(19) United States
(12) Patent Application Publication
(10) Pub. No.: US 2012/0193222 A1
(43) Pub. Date: Aug. 2, 2012

(54) Electrochemical Reactor for CO2 Conversion Utilization and Associated Carbonate Electrocatalyst

(75) Inventors: William Earl Mustain, JR., Manchester, CT (US); Jose Angel Vega, Medford, MA (US); Neil Scott Spinner, Manchester, CT (US)

(73) Assignee: UNIVERSITY OF CONNECTICUT, Farmington, CT (US)

(21) Appl. No.: 13/289,508

(22) Filed: Nov. 4, 2011

Related U.S. Application Data
(60) Provisional application No. 61/410,614, filed on Nov. 5, 2010.

(51) Int. Cl. C25B 9/00; B01J 23/58; B21D 51/16; B01J 23/40

(52) U.S. Cl. 204/252; 204/242; 502/326; 502/328; 29/890

(57) ABSTRACT

Electrochemical reactors are provided that operate on the carbonate cycle at extremely low temperatures (e.g., less than 50° C.), thereby allowing operation in as many as three (3) modes, namely as: (i) a room temperature carbonate fuel cell; (ii) an electrochemically assisted CO₂ membrane separator; and (iii) a CO₂ conversion device. Electrocatalysts are also provided that have the ability to selectively form carbonate anions over hydroxide anions under fully humidified conditions. Exemplary electrocatalysts according to the present disclosure include pyrochlores.

### CROSS-REFERENCE TO RELATED APPLICATION

The present application claims priority to a provisional patent application entitled “Electrochemical Reactor for CO₂ Conversion, Utilization and Associated Carbonate Electrocatalyst,” filed with the U.S. Patent and Trademark Office on Nov. 5, 2010, and assigned Ser. No. 61/410,614. The entire content of the foregoing provisional patent application is incorporated herein by reference.

### STATEMENT OF GOVERNMENT SUPPORT

The United States government may hold license and/or other rights in this invention as a result of financial support provided by governmental agencies in the development of aspects of the invention. Parts of this work were supported by a grant from the National Science Foundation, Grant No. CBET-1005303.

### BACKGROUND

1. Technical Field

The present disclosure is directed to electrochemical reactors and, more particularly, to electrochemical reactors that operate on a carbonate cycle at extremely low temperatures (e.g., less than about 50° C.), wherein the electrochemical reactors have improved performance characteristics, allowing operation in as many as three (3) modes, namely as: (i) a room temperature carbonate fuel cell; (ii) an electrochemically assisted CO₂ membrane separator; and (iii) a CO₂ conversion device. The present disclosure further provides an electrocatalyst and, more specifically, an electrocatalyst having the ability to selectively form carbonate anions over hydroxide anions under fully humidified conditions.

2. Background Art

In general, the price of petroleum is rising and prices are volatile. As petroleum-derived materials are integrated into nearly every market in the world, cost and uncertainty in oil prices has a considerably negative impact, e.g., by lowering consumer and market confidence, curtailing investment, reducing manufacturing, etc. This has led researchers and the chemical process industry to search for alternative feedstocks from cheaper, and preferably domestic, feedstocks.

In general, the US and the UK are world leaders with respect to the production of methane (i.e., natural gas). With recent discoveries in both countries, in addition to the introduction of renewable biogas (e.g., a mixture of primarily methane, CH₄, and carbon dioxide, CO₂) to the market, the availability of methane is generally at an all-time high and its inflation-corrected cost has risen only approximately 10% over the past 30 years and is expected to decrease over the next several years (see, e.g., U.S. Energy Information Administration, 25^{th} Anniversary of the 1973 Oil Embargo, available at http://www.eia.doe.gov/emeu/25opec/sld006.htm). This has made gas to liquid (“GTL”) conversion processes popular (see, e.g., Mokrani, T. et al., Gas Conversion to Liquid Fuels and Chemicals: The Methanol Route-Catalysis and Processes Development, Catalysis Reviews, 51, 1-145 (2009)). In GTL processes, methane is typically oxidized through steam reforming to syngas (i.e., CO+H₂). With reference to FIG. 1, this oxidation step is shown in step (1). The resulting syngas is then converted to methanol and/or dimethyl ether (“DME”). Both methanol and DME are high value chemicals and can be used to synthesize a wide variety of products, e.g., MTBE, synthetic gasoline, olefins, and the like, or used directly as fuels.

Though steam reforming is generally used in the industry and is well developed, it is expensive from a processing perspective for several reasons. First, industrial reactors for these processes are typically run in excess of about 700° C., which places stringent conditions on materials selection and requires high quality heat. Second, this reaction is strongly endothermic (e.g., ΔH about 200 kJ/mol), requiring a large amount of heat. From here, the conversion of syngas to methanol is both thermodynamically and kinetically favored and inexpensive from an industrial perspective. Thus, an interest exists for the discovery of a low temperature route to convert methane to syngas which would reduce industrial cost and provide a truly transformative technology for the processing of natural gas and biogas to higher order organics.

However, there are certain limitations for the thermochemical activation and conversion of methane. Upgrading of methane, the primary component of natural gas and biogas, to industrially relevant chemicals, e.g., methanol and other easily transportable liquid fuels, has been investigated over the last few decades. Despite research efforts into finding novel catalyst materials and reaction pathways, the activation of methane at low temperature, preferably approximately room temperature, has proven elusive and challenging. In conventional processes, the adsorption and thermochemical activation of methane is generally slow because: i) the C—H bond has a high dissociation energy (about 105 kcal/mole); ii) the C—H bond has low polarity; iii) the number of valence electrons and valence orbitals is the same, leaving no easily reactive lone pairs or empty orbitals; and iv) methane's tetrahedral structure has high steric hindrance (see, e.g., Zhidomirov, G. M. et al., Molecular Models of Active Sites of C₁ and C₂ hydrocarbon activation, Catalysis Today, 24, 383-387 (1995)). Thus, high temperatures or highly active catalysts are required.

In general, redox processes have been used to facilitate new reaction chemistries. Specifically, electrochemical reactions typically allow two control features that conventional heterogeneous processes do not: i) direct control of the surface free energy of the catalyst through the electrode potential, allowing the reaction rate and pathway selectivity to be dialed in, and ii) a non-direct reaction between precursors through complementary redox processes on two separate catalysts. This typically permits researchers to tailor the properties needed for each redox process independently, which allows for different reaction pathways depending on catalyst selection with identical precursors at the same reaction conditions while minimizing competition between alternate pathways. As such, this generally enables unique chemistries to occur that would not be possible in conventional systems.

Over the past several years, some electrochemical synthesis methods have received attention for the formation of high value products for the pharmaceutical and food industries. A first representative case is the hydrogenation of oils. For example, An et al. reported an electrochemical reactor with a proton exchange membrane, which utilized water as a hydrogen source for hydrogenation (see, e.g., An, W. et al., The Electrochemical Hydrogenation of Edible Oils in a Solid Polymer Electrolyte Reactor. I. Reactor Design and Operation, Journal of the American Oil Chemists' Society, 75, 917-925 (1998)). Also, the reactor was run at lower temperatures than traditional hydrogenation reactors and the product had higher cis-isomer selectivity, which has important implications for food products. A second representative case is the synthesis of caffeic acid derivatives, which are generally agriculturally and pharmacologically important as they have been shown to play a role in the infection defense mechanism of several plant species. Moghaddam and coworkers reported an electrochemical route for the formation of new caffeic acid derivatives that generally reduced the energy required for synthesis and eliminated the need for environmentally harmful reagents (see, e.g., Moghaddam, A. B. et al., A green method on the electro-organic synthesis of new caffeic acid derivates: Electrochemical properties and LC-ESI-MS analysis of products, Journal of Electroanalytical Chemistry, 601, 205-210 (2007)).

As such, electrochemical processes can be generally designed to control the adsorption and surface coverage of reactants and products, dictate reaction pathways and selectivity, reduce energy requirements for synthesis and lower operating temperatures compared with chemical routes.

Some of the electrochemical synthesis methods discussed above have been generally performed utilizing electrochemical devices. In general, electrochemical devices, such as, for example, fuel cells and batteries, are similar electrochemical devices that generate and/or store electrical energy. Fuel cells are typically different from batteries in that they generally consume reactant from an external source, which must be replenished. Thus, fuel cells are typically a thermodynamically open system.

Generally, a fuel cell is an electrochemical energy conversion device. Fuel cells typically produce electricity from fuel on the anode side and an oxidant on the cathode side. In general, the reactants flow into the cell, and react in the presence of an electrolyte. The reaction products typically flow out of it, while the electrolyte generally remains within it. Typically, fuel cells can operate virtually continuously as long as the necessary flows and the thermal balance is maintained.

Fuel cells are generally electrochemical cells in which a free energy change resulting from a fuel oxidation reaction is converted into electrical energy. Fuel cells are attractive electrical power sources due to their higher energy efficiency and environmental compatibility compared to, for example, the internal combustion engine. Some of the known fuel cells are those using a gaseous fuel (e.g., hydrogen) with a gaseous oxidant (e.g., pure oxygen or atmospheric oxygen), and those fuel cells using direct feed organic fuels such as methanol. Electrical energy from fuel cells may be produced for as long as the fuels, e.g., methanol or hydrogen, and oxidant, are supplied. Thus, an interest exists in the design of improved fuel cells to fill future energy needs.

The anion exchange membrane fuel cell (AEMFC) is a type of fuel cell that has been of interest in the industry due to its improved performance and characteristics. Several research groups have worked on the hydroxide exchange membrane fuel cell (HEMFC), an AEMFC implementing a hydroxide anion, as an energy conversion device (see, e.g., Varcoe, J. R. et al., Prospects for Alkaline Anion Exchange Membranes in Low Temperature Fuel Cells, Fuel Cells, (2005) 187; Park, J. et al., Performance of solid alkaline fuel cells employing anion-exchange membranes, Journal of Power Sources, 178 (2008) 620; Agel, E. et al., Characterization and use of anionic membranes for alkaline fuel cells, Journal of Power Sources, 101 (2001) 267; Yu, E. H. et al., Development of direct methanol alkaline fuel cells using anion exchange membranes, Journal of Power Sources, 137 (2004) 248; Yu, E. H. et al., Direct methanol alkaline fuel cell with catalysed metal mesh anodes, Electrochemistry Communications, 6 (2004) 361; Li, L. et al., Quaternized polyethersulfone cardo anion exchange membranes for direct methanol alkaline fuel cells, Journal of Membrane Science, 262 (2005)1; Slade, R C. T. et al., Investigations of conductivity in FEP-based radiation-grafted alkaline anion-exchange membranes, Solid State Ionics, 176 (2005) 585; Wu, Y. et al., Novel anion-exchange organic-inorganic hybrid membranes: Preparation and characterizations for potential use in fuel cells, Journal of Membrane Science, 321 (2008) 299; Varcoe, J. R. et al., Steady-State dc and Impedance Investigations of H2/02 Alkaline Membrane Fuel Cells with Commercial Pt/C, Ag/C, and Au/C Cathodes, J. Phys. Chem. B., 110 (2006) 21041; Xiong, Y. et al., Preparation and characterization of cross-linked quaternized poly(vinyl alcohol) membranes for anion exchange membrane fuel cells, Journal of Membrane Science, 311 (2008) 319; Hou, H. et al., Alkali doped polybenzimidazole membrane for high performance alkaline direct ethanol fuel cell, Journal of Power Sources, 182 (2008) 95; Wu, Y. et al., Free-standing anion-exchange PEO—Si02 hybrid membranes, Journal of Membrane Science, 307 (2008) 28; Wu, L. et al., Improving anion exchange membranes for DMAFCs by inter-crosslinking CPPO/BPPO blends, Journal of Membrane Science, 322 (2008) 286; Lu, S. et al., Alkaline polymer electrolyte fuel cells completely free from noble metal catalysts, PNAS, 105 (2008) 20611; Varcoe, J. R., Investigations of the ex situ ionic conductivities at 30° C. of metal-cation-free quaternary ammonium alkaline anion-exchange membranes in static atmospheres of different relative humilities, Phys. Chem. Chem. Phys., 9 (2007) 1479; Yanagi, H. et al., Anion Exchange Membrane and Ionomer for Alkaline Membrane Fuel Cells (AMFCs), ECS Transactions, 16 (2008) 257; Fujiwara, N. et al., Direct ethanol fuel cells using an anion exchange membrane, Journal of Power Sources, 185 (2008) 621; Sata, T. et al., Change of anion exchange membranes in an aqueous sodium hydroxide solution at high temperature, Journal of Membrane Science, 112 (1996) 161; Varcoe, J. R et al., An alkaline polymer electrochemical interface: a breakthrough in application of alkaline anion-exchange membranes in fuel cells, Chem. Commun., 13 (2006) 1428; and Torres, C. I. et al., Carbonate Species as OH-Carriers for Decreasing the pH Gradient between Cathode and Anode in Biological Fuel Cells, Environmental Science and Technology, 42 (2008) 8773). In general, the HEMFC is a modification of the traditional alkaline fuel cell (AFC), where the liquid potassium hydroxide electrolyte is replaced with a compact, solid polymer electrolyte, which simplifies cell design and construction and typically increases the intrinsic energy density of the device.

The HEMFC also offers several advantages over its acidic electrolyte counterpart, the proton exchange membrane fuel cell (PEMFC), including: (i) enhanced kinetics for both the oxygen reduction reaction (ORR) on non-Pt catalysts and hydrogen oxidation reactions (HOR) on Pt and non-Pt catalysts with less costly electrocatalysts, (ii) reduction in fuel crossover due to the suppression by the electroosmotic drag resulting from the anion transport from cathode to anode during operation, and (iii) lower cost membrane electrolytes (see, e.g., Kiros, Y. et al., Long-term hydrogen oxidation catalysts in alkaline fuel cells, Journal of Power Sources, 87 (2000) 101; Alcaide, F. et al., Hydrogen Oxidation Reaction in a Pt-Catalyzed Gas Diffusion Electrode in Alkaline Medium, J. Electrochem. Soc., 152 (2005) E319; Lasia, A., Hydrogen evolution/oxidation reactions on porous electrodes, Journal of Electroanalytical Chemistry, 454 (1998) 115; Zhang, J. et al., High catalytic activity of nanostructured Pd thin films electrochemically deposited on polycrystalline Pt and Au substrates towards electro-oxidation of methanol, Electrochemistry Communications, 9 (2008) 1298; Hernandez, J. et al., Methanol oxidation on gold nanoparticles in alkaline media: Unusual electrocatalytic activity, Electrochimica Acta, 52 (2006) 1662; and Tripkovic, A. et al., Methanol oxidation at platinum electrodes in alkaline solution: comparison between supported catalysts and model systems, Journal of Electroanalytical Chemistry, 572 (2004) 119; Erikson, H et al., Electrochimica Acta, 54, 7483 (2009); Markovic, N. M. et al., Oxygen Reduction on Platinum Low-Index Single-Crystal Surfaces in Alkaline Solution: Rotating Ring DiskPt(hkl) Studies, J. Phys. Chem., 100 (1996) 6715; Genies, L. et al., Electrochemical reduction of oxygen on platinum nanoparticles in alkaline media, Electrochimica Acta, 44 (1998) 1317; Anastasijevic, N. A. et al., Oxygen reduction on a ruthenium electrode in alkaline electrolytes, J. Electroanal. Chem., 199 (1986) 351; Demarconnay, L. et al., Electroreduction of dioxygen (ORR) in alkaline medium on Ag/C and Pt/C nanostructured catalysts—effect of the presence of methanol, Electrochimica Acta, 49 (2004) 4513; and Longo, J. M. et al., Pb2M207-x (M=Ru, Ir, Re)—Preparation and properties of oxygen deficient pyrochlores, Mat. Res. Bull., 4 (1969) 191; Hernandez, J. et al., Methanol oxidation on gold nanoparticles in alkaline media: Unusual electrocatalytic activity, Electrochimica Acta, 52 (2006) 1662; Tripkovic, A. et al., Methanol oxidation at platinum electrodes in alkaline solution: comparison between supported catalysts and model systems, Journal of Electroanalytical Chemistry, 572 (2004) 119; Narayanan, S. R. et al., Recent advances in PEM liquid-feed direct methanol fuel cells, Annu. Battery Conf. Appl. Adv., 11 (1996): 113; Cruickshank, J. et al., The degree and effect of methanol crossover in the direct methanol fuel cell, J. Power Sources, 70 (1998): 40-47; and Scott, K. et al., Performance of a direct methanol fuel cell, J. Appl. Electrochem., 28 (1998) 289).

Also, alcohol versions of HEMFCs can operate on pure fuel since water does not take part on the anode reaction, contrary to PEMFCs where the fuel must be diluted. In addition, water is produced at the anode and partially consumed at the cathode, potentially simplifying water management and preventing electrode flooding. Finally, there have also been promising reports of HEMFCs operating with hydrogen and alcohol fuels (see, e.g., Agel, E. et al, J. Power Sources, 101, 267 (2001); Li, L. et al., J. Membrane Sci., 262, 1 (2005); Hebrard, G. et al., Chem. Eng. J., 148, 132 (2009); Yu, E. et al., J. Power Sources, 137, 248 (2004); Wu, Y. et al., J. Membrane Sci., 307, 28 (2008); Xiong, Y. et al., J. Membrane Sci., 311, 319 (2008); and Yu, E. et al., Electrochem. Commun., 6, 361 (2004)).

However, the HEMFC has some troublesome technical limitations. State-of-the-art anion exchange membranes with nitrogen functionalities typically undergo a catalyzed degradation by hydroxide anions through nucleophilic attack and Hofmann elimination reactions (see, e.g., Varcoe, J. R. et al., Prospects for Alkaline Anion Exchange Membranes in Low Temperature Fuel Cells, Fuel Cells, 5 (2005) 187; Li, L. et al., Quaternized polyethersulfone Cardo anion exchange membranes for direct methanol alkaline fuel cells, Journal of Membrane Science, 262 (2005)1; Slade, R C. T. et al., Investigations of conductivity in FEP-based radiation-grafted alkaline anion-exchange membranes, Solid State Ionics, 176 (2005) 585; Wu, Y. et al., Novel anion-exchange organic-inorganic hybrid membranes: Preparation and characterizations for potential use in fuel cells, Journal of Membrane Science, 321 (2008) 299; Varcoe, J. R. et al., Steady-State dc and Impedance Investigations of H2/02 Alkaline Membrane Fuel Cells with Commercial Pt/C, Ag/C, and Au/C Cathodes, J. Phys. Chem. B., 110 (2006) 21041; and Xiong, Y. et al., Preparation and characterization of cross-linked quaternized poly(vinyl alcohol) membranes for anion exchange membrane fuel cells, Journal of Membrane Science, 311 (2008) 319). Moreover, the pH at the HEMFC cathode pH is typically in excess of 14. These are complex hurdles to overcome with current technologies and device chemistries as the purpose of the HEMFC cathode catalyst is to produce hydroxide as quickly as possible (i.e., high current) and the purpose of the electrolyte is to have both high solubility and high mobility of OH-ions in order to increase conductivity (i.e., low internal resistance). To address this fundamental limitation, an anionic charge-carrying species that will lower the localized pH at the electrocatalyst surface while maintaining high ionic conductivity would be highly advantageous.

Consequently, several researchers have started investigating AEMFCs that operate on the carbonate cycle (see, e.g., Lang, C. et al., Electrochem. Solid State, 9, A545 (2006); Adams, L. A. et al., ChemSusChem, 1, 79 (2008); Zhou, J. et al., J. Power Sources, 190, 285 (2009); and Vega, J. A. et al., Electrochimica Acta, 55, 1638 (2010)). Carbonate anions have long been used as a reliable charge-carrying species in a molten carbonate fuel cell (MCFC) (see, e.g., Selman, R. J., 5. Molten carbonate fuel cells (MCFCs), Energy, 11 (1986) 153; Maru, H. C. et al., Molten Carbonate Fuel Cell Product Design Improvement, prepared for US DOE/DARPA, Annual Report, DE-FC21-95MC31184; K. Jooh, Critical issues and future prospects for molten carbonate fuel cells, Journal of Power Sources, 61 (1996) 129; Dicks, A. L., Molten carbonate fuel cells, Current Opinion in Solid State and Materials Science, 8 (2004) 379; and Dicks, A. et al., Assessment of commercial prospects of molten carbonate fuel cells, Journal of Power Sources, 86 (2000) 316). Though the MCFC has shown promise as an efficient electrochemical power source, its high operating temperature (>650° C.) has increased system complexity, significantly elevating cost despite having non-noble metal electrocatalysts. In the MCFC, CO₃⁻² anions are fanned at the cathode by the electrochemical activation of oxygen on the electrocatalyst, where four electrons are accepted. The activated oxygen species then chemically reacts with strongly adsorbed carbon dioxide, forming the carbonate anion. This “direct pathway” is shown in Equations 1-2.

O₂+4e⁻→2O⁻² (1)

2O⁻²+2CO₂→2CO₃⁻², E⁰=0.62 V (2)

However, in the presence of water, the carbonate anion is preferentially formed by chemical reaction of carbon dioxide with hydroxide anions. Specifically, carbonate anions should be produced at the cathode by the selective reduction of O₂ and CO₂ (Equation 5), instead of O₂ and H₂O (Equation 3). This “hydroxide pathway” is summarized in Equations 3-4.

O₂+2H₂O+4e⁻→4OH⁻, E⁰=0.40 V (3)

4OH⁻+2CO₂→2CO₃⁻²+2H₂O, exothermic (4)

Equations 3 and 4 together yield the following:

O₂+2CO₂+4e⁻→2CO₃⁻² (5)

The direct pathway is typically preferred for the following reasons. First, the hydroxide pathway has a lower theoretical potential, leading to at least a 20% reduction in power when the device is active. For example, it has been shown that electrolyte degradation is suppressed in concentrated carbonate environments (see, e.g., Zhou, J. et al., J. Power Sources, 190, 285 (2009) and Vega, J. A. et al., J. Power Sources, 195, 7176 (2010)). Second, OH⁻ is still present locally at the cathode catalyst operating on the hydroxide pathway. This means that the electrolyte adjacent to the catalyst will still be unstable and undergo degradation. Third, hydrogen oxidation has been shown to be kinetically favored with carbonate anions, compared to hydroxide anions (see, e.g., Vega, J. A. et al., J. Electrochem. Soc., 158, B349 (2011)). This could lead to improved long-term performance of a room temperature (e.g., from about 15° C. to about 40° C.) carbonate fuel cell (RTCFC), compared to the HEMFC. However, conventional catalysts, e.g., Pt/C, have a low selectivity towards CO₂ adsorption and electrochemical carbonate formation due to their low surface alkalinity and wetting properties. Therefore, it is desired that electrocatalysts are implemented that preferentially operate through the “direct” pathway.

In the alkaline fuel cell (AFC), Equation 4 is the main obstacle regarding commercialization for terrestrial applications due to carbonate saturation and salting on the cathode catalyst. This is caused by the aqueous KOH electrolyte in the AFC, where K⁺ combines with free CO₃⁻² to form K₂CO₃, which has an extremely low solubility in water. However, there is substantially no evidence for carbonate salting in the HEMFC. This is expected as there are no free cations present in the HEMFC. Therefore, carbonate anions are freely transported through anion exchange membranes (see, e.g., Xiong, Y. et al., Preparation and characterization of cross-linked quaternized poly(vinyl alcohol) membranes for anion exchange membrane fuel cells, Journal of Membrane Science, 311 (2008) 319; Adams, L. A. et al., A Carbon Dioxide Tolerant Aqueous-Electrolyte-Free Anion-Exchange Membrane Alkaline Fuel Cell, ChemSusChem, 1 (2008) 79; and Lang, C. M. et al., High-Energy Density, Room-Temperature Carbonate Fuel Cell, Electrochemical and Solid State Letters, 9 (2006) A545). However, this suggests that in order for an electrochemical device operating on the carbonate cycle to perform effectively, it needs to be shown that carbonate anions can readily oxidize common fuels, which has not yet been shown at lower temperatures. The redox reactions for hydrogen and methanol with CO₃⁻² are shown below.

H₂+CO₃⁻² [symbol] H₂O+CO₂+2e⁻, E⁰=−0.61 V (6)

CH₃OH+3CO₃⁻² [symbol] 4CO₂+2H₂O+6e⁻, E⁰=−0.59 V (7)

In addition, several characteristics are typically necessary for an electrochemical catalyst to produce CO₃⁻² over OH⁻. High electrical conductivity and electrochemical activity are generally necessary to facilitate the electron transfer process and activate the oxygen double-bond. Also, the catalyst should show preferential surface adsorption of carbon dioxide over water. The selective electrochemical formation of carbonate may be accomplished by the use of; for example, alkaline earth-based pyrochlore oxides, A₂B₂O_{7-y}. Introduction of alkaline earth metals on the “A” site can yield a pyrochlore catalyst with a high surface basicity, which can lead to the preferential adsorption of CO₂ over H₂O, since CO₂ is a stronger Lewis acid compared to H₂O, providing preferential adsorption through Lewis acid-base interactions. This preferential adsorption has been observed for the conversion of NO on CaO (see, e.g., Fliatoura, K. D. et al., J. Catal., 183, 323 (1999)). Therefore, Ca is a feasible candidate for the “A” site of the pyrochlore to attain a high surface basicity. In turn, the “B” site could be used to introduce metals with ORR activity in alkaline media. The introduction of ruthenium in the “B” site has resulted in lead ruthenate pyrochlore and has shown electrochemical activity towards the ORR (see, e.g., Prakash, J. et al., J. Electrochem. Soc., 146, 4145 (1999)). Therefore, a calcium ruthenate pyrochlore, Ca₂Ru₂O_{7-y}, should have the desired high surface basicity along with ORR activity.

Additionally, it has recently been demonstrated that Ca₂Ru₂O_{7-y} showed very low resistivity at room temperature (see, e.g., Munenaka, T. et al., J. Phys. Soc. Japan, 75, 103801 (2006)). However, the high temperature and pressure synthesis conditions (about 600° C. and 150 MPa) produced large particles (about 100 μm) and yielded a low surface area, an undesirable property for a fuel cell catalyst. Therefore, it is desired to find a synthesis method which will yield a high surface area calcium ruthenate pyrochlore, followed by evaluation as a selective carbonate catalyst.

Thus, despite efforts to date, a need remains for enhanced electrochemical reactor systems and associated catalyst systems. In particular, alternatives to carbonate based fuel cells that currently operate above 400° C. (and more commonly at or above 650° C.) are desired, as are alternative CO₂ conversion devices to address shortcomings of conventional CO₂ conversion devices that currently operate at high pressure and elevated temperature, thereby making such devices very expensive to operate. Still further, catalyst systems are needed for use in anion exchange membrane fuel cells that offer highly desirable performance stability. Moreover, a need remains for a low temperature route to convert methane to syngas which reduces industrial cost and provides a transformative technology for the processing of natural gas and biogas to higher order organics. These and other needs are met by the systems, catalysts and methods of the present disclosure.

### SUMMARY

The present disclosure provides advantageous electrochemical reactors that operate on the carbonate cycle at extremely low temperatures (e.g., less than about 50° C.), thereby allowing operation in as many as three (3) modes, namely as: (i) a room temperature carbonate fuel cell; (ii) an electrochemically assisted CO₂ membrane separator; and (iii) a CO₂ conversion device. Thus, for all modes of operation, exemplary embodiments of the disclosed electrochemical device operate at (or relatively close to) room temperature and atmospheric pressure. Also, the materials requirements of the disclosed electrochemical reactors are not demanding and device sealing is not an issue. Accordingly, the present disclosure provides a low cost alternative to conventional technologies for any (or all) of the three applications/modes of operation noted above.

The present disclosure further provides an electrocatalyst with the ability to selectively form carbonate anions over hydroxide anions under fully humidified conditions. The ability of the disclosed electrocatalyst to catalyze formation of carbonate anions over hydroxide at room temperature offers many advantages, including much higher stability for next generation anion exchange membrane fuel cells.

Thus, the disclosed electrochemical reactor that is operational at (or relatively close to) room temperature (e.g., from about 15° C. to about 40° C.) provides at least two critical improvements over conventional HEMFC systems. First, the low pKa for the carbonate-bicarbonate equilibrium, Equation 8, will lead to reduced electrolyte degradation by significantly reducing the localized pH at the cathode.

CO₃⁻²+H₂O [symbol] HCO₃⁻+OH⁻, pKa=10.3 (8)

Second, the disclosed electrochemical device is able to act as a “carbon pump”, essentially purifying atmospheric CO₂, which may then be stored, utilized in chemical processes and/or sequestered. Therefore, CO₃⁻² is an extremely promising replacement ion for OH⁻ in low temperature electrochemical reactors and its use as the charge carrier in the disclosed carbonate fuel cell has the potential to provide enhanced performance and durability at lower cost than both the PEMFC and HEMFC with a net negative CO₂ footprint.

The present disclosure provides for an electrochemical reactor including an anode electrically coupled to a cathode; an electrolyte in communication with the anode and the cathode; wherein the anode, cathode and the electrolyte are adapted to operate at a temperature of about 50° C. or less to: (i) produce carbonate anions at the cathode, and (ii) transport the carbonate anions from the cathode to the anode via the electrolyte.

The present disclosure also provides for an electrochemical reactor wherein the anode, cathode and the electrolyte are adapted to operate at about atmospheric pressure to produce and transport the carbonate anions. The present disclosure also provides for an electrochemical reactor wherein the carbonate anions are produced via the following equation:

O₂+2CO₂+4e⁻2CO₃⁻².

The present disclosure also provides for an electrochemical reactor wherein the electrolyte is a substantially solid, polymer electrolyte. The present disclosure also provides for an electrochemical reactor wherein the electrolyte is substantially non-electrically conducting, and includes functional groups that allow for the transport of ions through the functional groups.

The present disclosure also provides for an electrochemical reactor wherein when a fuel is fed to the anode, the fuel is oxidized by the carbonate anions, thereby yielding CO₂ and water via the following equation:

2H₂+2CO₃⁻²→2CO₂+2H₂O+4e⁻.

The present disclosure also provides for an electrochemical reactor wherein the yielded CO₂ is emitted from the anode or recycled to the cathode. The present disclosure also provides for an electrochemical reactor wherein the yielded CO₂ is separated from the H₂O via a separator. The present disclosure also provides for an electrochemical reactor wherein the fuel is hydrogen or alcohol. The present disclosure also provides for an electrochemical reactor further including a catalyst associated with the anode, the catalyst adapted to absorb the produced carbonate anions and oxidize an incoming anode feed.

The present disclosure also provides for an electrochemical reactor wherein the anode feed is oxidized to form dimethyl carbonate or formaldehyde. The present disclosure also provides for an electrochemical reactor wherein the anode, cathode and the electrolyte are adapted to operate at a temperature of about 15° C. to about 40° C. to produce and transport the carbonate anions. The present disclosure also provides for an electrochemical reactor further including a catalyst associated with the cathode, the catalyst adapted to selectively form carbonate anions over hydroxide anions under fully humidified conditions.

The present disclosure also provides for an electrochemical reactor wherein the catalyst preferentially absorbs CO₂ over H₂O, catalytically activates the O═O bond, and has high electronic conductivity. The present disclosure also provides for an electrochemical reactor wherein the catalyst is tri-functional and is a single compound. The present disclosure also provides for an electrochemical reactor wherein the catalyst is an alkaline earth pyrochlore.

The present disclosure also provides for an electrochemical reactor wherein the catalyst has a molecular structure of A₂B₂O_{7-y}, and wherein the A and B sites may be individually controlled to tailor the catalytic properties of the catalyst and the oxygen vacancy (y) gives the catalyst conductivity. The present disclosure also provides for an electrochemical reactor wherein an alkaline earth metal is selected from the group consisting of Ca, Mg, Ba and Sr is at the A site.

The present disclosure also provides for an electrochemical reactor wherein a high activity oxygen reduction reaction catalyst in alkaline media is at the B site. The present disclosure also provides for an electrochemical reactor wherein the A and B sites take the form of single components. The present disclosure also provides for an electrochemical reactor wherein the A and B sites take the form of combined components.

The present disclosure also provides for an electrochemical reactor wherein the A site takes the form of a combination of Ca_{0.5} and Ba_{1.5}. The present disclosure also provides for an electrochemical reactor wherein the B site takes the form of RuPt.

The present disclosure also provides for an electrocatalyst including a pyrochlore having a molecular structure of A₂B₂O_{7-y}, wherein the A and B sites may be individually controlled to tailor the catalytic properties of a disclosed catalyst, and the oxygen vacancy gives the catalyst conductivity.

The present disclosure also provides for an electrocatalyst wherein the pyrochlore is an alkaline earth pyrochlore. The present disclosure also provides for an electrocatalyst wherein an alkaline earth metal is selected from the group consisting of Ca, Mg, Ba and Sr is at the A site.

The present disclosure also provides for an electrocatalyst wherein a high activity oxygen reduction reaction catalyst in alkaline media is at the B site. The present disclosure also provides for an electrocatalyst wherein the A and B sites take the form of single components. The present disclosure also provides for an electrocatalyst wherein the A and B sites take the form of combined components.

The present disclosure also provides for an electrocatalyst wherein the A site takes the form of a combination of Ca_{0.5} and Ba_{1.5}. The present disclosure also provides for an electrocatalyst wherein the B site takes the form of RuPt. The present disclosure also provides for an electrocatalyst wherein the catalyst is Ca₂Ru₂O_{7-y}. The present disclosure also provides for an electrocatalyst wherein the pyrochlore is Ca₂Ru₂O_{7-y}. The present disclosure also provides for an electrocatalyst wherein the catalyst is Ca_{1.5}Ba_{0.5}PtRu_{O7-y}. The present disclosure also provides for an electrocatalyst wherein the pyrochlore is Ca_{1.5}Ba_{0.5}PtRu_{O7-y}.

The present disclosure also provides for a method of fabricating an electrochemical reactor, the method including: a. providing an anode electrically coupled to a cathode; and b. providing an electrolyte in communication with the anode and the cathode, wherein the anode, cathode and the electrolyte are adapted to operate at a temperature of about 50° C. or less to: (i) produce carbonate anions at the cathode, and (ii) transport the carbonate anions from the cathode to the anode via the electrolyte.

The present disclosure also provides for a method of fabricating an electrochemical reactor wherein the anode, cathode and the electrolyte are adapted to operate at about atmospheric pressure to produce and transport the carbonate anions.

The present disclosure also provides for a method of fabricating an electrochemical reactor further including providing a catalyst associated with the anode, the catalyst adapted to absorb the produced carbonate anions and oxidize an incoming anode feed. The present disclosure also provides for a method of fabricating an electrochemical reactor further including providing a catalyst associated with the cathode, the catalyst adapted to selectively form carbonate anions over hydroxide anions under fully humidified conditions.

The present disclosure also provides for an electrochemical reactor wherein the anode feed is oxidized to form syngas. The present disclosure also provides for an electrochemical reactor wherein the anode feed includes methane or a mixture of methane and carbon dioxide.

The present disclosure also provides for an electrochemical reactor wherein the catalyst is a co-precipitated transition metal oxide:ZrO₂ electrocatalyst. The present disclosure also provides for an electrochemical reactor wherein the catalyst is selected from the group consisting of a co-precipitated NiO/ZrO₂ composite catalyst, a co-precipitated CoO/ZrO₂ composite catalyst and a co-precipitated MnO/ZrO₂ composite catalyst.

Additional features, functions and benefits of the disclosed electrochemical reactors and electrochemical catalysts will be apparent from the detailed description which follows, particularly when read in conjunction with the accompanying figures. All references listed in this disclosure are hereby incorporated by reference in their entireties.

### BRIEF DESCRIPTION OF THE FIGURES

To assist those of ordinary skill in the art in making and using the disclosed systems and catalysts, reference is made to the accompanying figures, wherein:

FIG. 1 is a schematic of an exemplary gas to liquid conversion process;

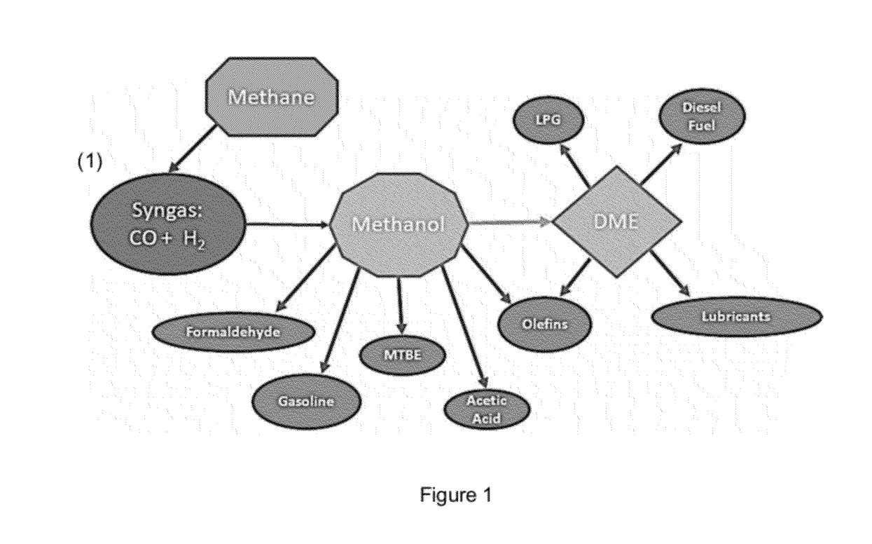

FIG. 2 is a schematic depicting an exemplary carbonate fuel cell according to the present disclosure;

FIG. 3 is a schematic depicting an exemplary carbonate fuel cell and electrochemically-assisted membrane separator according to the present disclosure;

FIGS. 4(a) and (b) are schematics depicting exemplary electrochemical reactors adapted to function as methane conversion devices according to the present disclosure;

FIG. 5 is a schematic depicting an exemplary device that is adapted to function as a carbonate device for electrochemical conversion of CO₂ according to the present disclosure;

FIG. 6 is a plot of ionic conductivity vs. time for a plurality of devices functioning as anion exchange membrane fuel cells;

FIG. 7 is a plot of ionic conductivity vs. time for a plurality of devices functioning as room temperature electrochemical carbonate reactors (fuel cell mode);

FIG. 8 is a schematic depicting the CE experimentation set-up using constant current operation to show carbonate cycle selectivity;

FIG. 9 is a plot of EN vs. current that demonstrates cathode selectivity for carbonate formation using an advantageous catalyst (Ca₂Ru₂O_{7-y}) according to the present disclosure;

FIG. 10 is a plot of polarization curves collected at 50 mV/s between OCV and about −2V with humidified N₂ used as the anode stream and several different cathode streams;

FIG. 11 is a plot depicting cathode streams containing O₂ with 0% and 10% CO₂;

FIG. 12 is a plot of linear sweep polarization curves for the RTCFC with different CO₂ concentrations in the cathode stream at 10 mV/s and 50° C.;

FIG. 13 is a plot of chronoamperometric curves for AEMFC using Ca₂Ru₂O_{7-y} as a cathode catalyst with different CO₂ content in the cathode stream operated at 0.25V;

FIG. 14 is a plot of CVs for a thin-film Ca₂Ru₂O_{7-y} electrode in N₂-saturated 1M KOH at 25° C. and 10 mV/s;

FIG. 15 is a plot of cathodic voltammograms for the Ca₂Ru₂O_{7-y} electrode in O₂-saturated 1M KOH at 25° C., 10 mV/s and 900 RPM;

FIG. 16 are Tafel plots for the O₂-saturated 1M KOH electrolyte with and without CO₂;

FIG. 17 is a plot of the XRD pattern of CaO and RuO₂ mixtures that were heat treated at several temperatures up to 900° C.;

FIG. 18 is a plot of the XRD pattern for samples synthesize through Method 2 at 75° C. and pH=14 for (a)1, (b) 2 and (c) 3 days using a 1:1 calcium to ruthenium molar ratio;

FIG. 19 is a plot of the in-situ XRD pattern for the precipitate obtained using Method 2 at 75° C., pH=14 and 1:1 Ca:Ru molar ration for three days heated to different temperatures in air;

FIG. 20 is a plot of the XRD pattern for samples synthesized by Method 3 at 200° C., 1M KOH and 10 mM KMnO₄ for (a) 0.5, (b)1, (c) 3 and (d) 5 days; and

FIG. 21 is a plot of in-situ XRD patterns for the product synthesized through Method 3 at 200° C., pH=14, 10 mM KMnO₄ and 1:1 Ca:Ru molar ratio for three days heated to several temperatures up to 600° C.

FIGS. 22(a)-(d) are SEM images of the pyrochlore synthesized through Method 3;

FIGS. 23(a) and (b) are TPD plots of Pt/C and Ca₂Ru₂O_{7-y} after exposure to humidified He or CO₂;

FIG. 24 is a plot of linear sweep voltammograms for Ca₂Ru₂O₇ in O₂ and O₂/CO₂ electrolytes;

FIG. 25 is a plot of cyclic voltammograms for NiO:ZrO₂ (80:20) composite electrodes in carbonate electrolyte;

FIG. 26 is a plot of performance curves for control and conversion experiments; and

FIG. 27 is a plot of mass spectrum for N₂ and CH₄ fuel.

### DESCRIPTION OF EXEMPLARY EMBODIMENT(S)

The present disclosure provides advantageous electrochemical reactors. More particularly, the present disclosure provides for improved electrochemical reactors that operate on the carbonate cycle at extremely low temperatures (e.g., less than about 50° C.), thereby allowing operation in as many as three (3) modes, namely as: (i) a room temperature carbonate fuel cell; (ii) an electrochemically assisted CO₂ membrane separator; and (iii) a CO₂ conversion device. The present disclosure further provides an electrocatalyst with the ability to selectively form carbonate anions over hydroxide anions under fully humidified conditions. The disclosed systems/catalysts have wide ranging application, e.g., in connection with fuel cells, batteries, heterogeneous transesterification of oils for biodiesel, electrochemically-assisted carbon sequestration, reduction of nitrous oxides (e.g., in automotive pollution prevention), and water treatment and electrolysis.

The present disclosure further provides an electrochemical energy conversion reactor that operates at about room temperature on the “direct” carbonate pathway. In an exemplary device, oxygen and carbon dioxide are fed to the cathode, which are reduced to carbonate anions (Equations 1-2 above). CO₃⁻² then travels through the membrane electrolyte from the cathode to the anode. At the anode, the carbonate anions oxidize the fuel, (e.g., hydrogen or methanol (Equations 6-7)), yielding water and CO₂. Electrons travel through an external circuit, both generating power and completing the electrochemical cell. Though this process is CO₂ neutral, the anode effluent is high purity water and CO₂, which can be easily separated using conventional methods. Both effluent species can be utilized to advantage, e.g., water for a myriad of applications, such as drinking, and CO₂ can be utilized in chemical processing or sequestered. Combining this reactor with a CO₂ consuming process or sequestration technology gives it the potential to provide power with a net negative CO₂ footprint.

1. Room Temperature Carbonate Fuel Cell

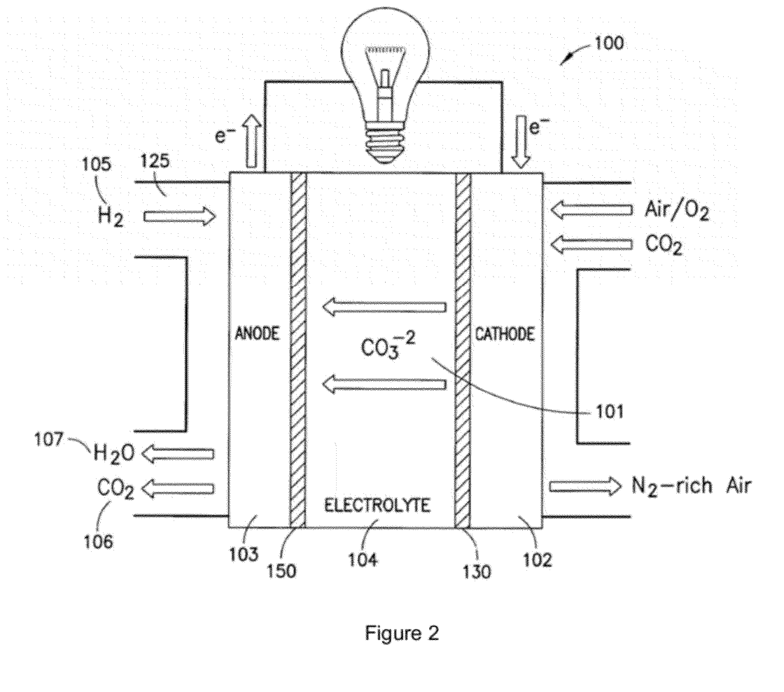

With reference to FIG. 2, a schematic diagram of an exemplary carbonate fuel cell 100 is depicted according to the present disclosure. In exemplary embodiments, the carbonate fuel cell 100 includes a combined system for the operation of a room temperature carbonate fuel cell with integrated CO₂ capture. In general and in any operating mode, carbonate anions 101 are produced at the device cathode 102 by the reaction set forth above in Equation 1. These carbonate anions 101 are transported from the cathode 102 to the anode 103 by a solid, polymer electrolyte 104 (e.g., AMI-7001S available from Membranes International, AMB-SS available from ResinTech, Ralex AMH-PAD available from Mega a.s., Excellion 1-200 available from SnowPure, and MA-3475 available from Lanxess Sybron). In exemplary embodiments, the solid electrolyte 104 is non-electrically conducting, but has functional groups that allow the transport of ions through them. Although not limited to such functional groups, quaternary ammonium groups (e.g., benzyltrimethyl ammonium or the like) have been implemented/utilized. In general, hydrogen (105) is fed to the anode 103 at an anode feed 125 where it is oxidized by the carbonate anions 101 produced at the cathode 102, yielding CO₂ (106) and water (107) as the products (Equation 2).

In exemplary embodiments, device 100 typically includes a catalyst 150 (e.g., a platinum based catalyst, etc., as described below) that is associated with the anode 103, and a catalyst 130 (e.g., Ca₂Ru₂O_{7-y}, as discussed below) that is associated with the cathode 102. In general, catalyst 130 is adapted to selectively form carbonate anions over hydroxide anions under fully humidified conditions. Moreover, catalyst 130 preferentially absorbs CO₂ over H₂O, catalytically activates the O═O bond, and has high electronic conductivity. In exemplary embodiments, catalyst 130 is tri-functional and is a single compound. In one embodiment, catalyst 130 is an alkaline earth pyrochlore. Catalyst 130 may have a molecular structure of A₂B₂O_{7-y}, wherein the A and B sites may be individually controlled to tailor the catalytic properties of the catalyst 130 and the oxygen vacancy (y) gives the catalyst 130 high electronic conductivity. Exemplary catalysts 130 are discussed in further detail below.

2. Electrochemically Assisted CO₂ Membrane Separator

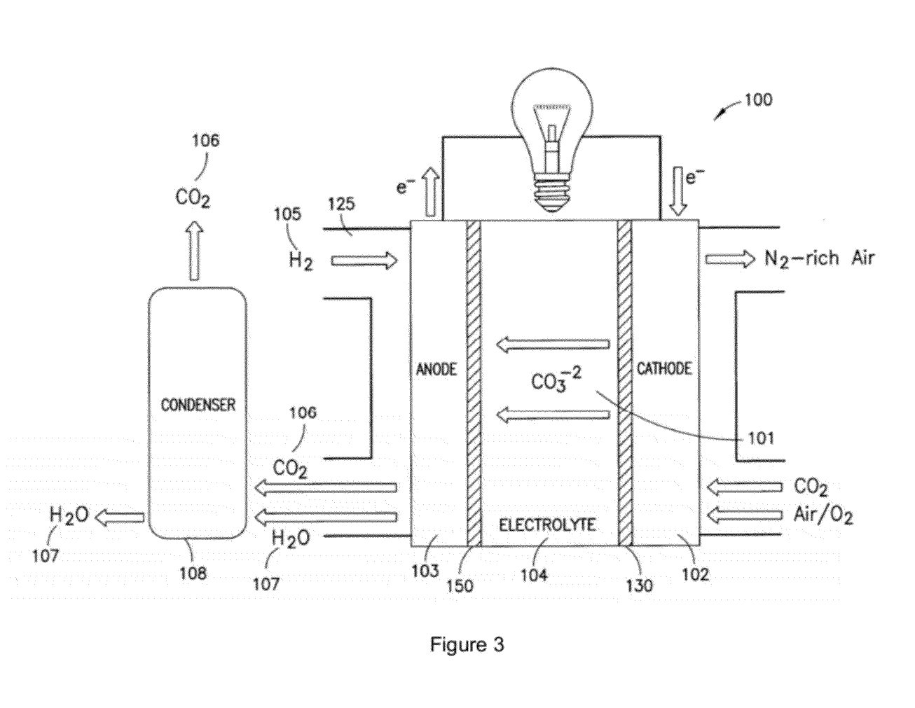

Now with reference to FIG. 3, a schematic diagram of an exemplary carbonate fuel cell 100 with an electrochemically-assisted membrane separator 108 is depicted according to the present disclosure. In general, the mode of operation of the carbonate fuel cell 100 is dictated by what happens at the anode 103. When operating in fuel cell mode, as schematically depicted in FIG. 3, hydrogen (105) is fed to the anode 103 where it is oxidized by the carbonate anions 101 produced at the cathode 102, yielding CO₂ (106) and water (107) as the products via the following equation:

2H₂+2CO₃⁻²→2H₂O+2CO₂+4e⁻.

This CO₂ (106) can either be emitted, recycled to the cathode 102 or separated from the water (107) via a separator 108, i.e., a condenser, and stored/sequestered. This processing scheme makes the disclosed room temperature carbonate reactor, i.e., carbonate fuel cell 100, a combined power device as well as an electrochemically assisted membrane separator 108. Of note, an alcohol (e.g., methanol, ethanol, ethylene glycol, etc.) fuel can be used in the place of the H₂ (105) reactant identified in FIGS. 2-3.

As noted above, device 100 typically includes a catalyst 150 that is associated with the anode 103, and a catalyst 130 that is associated with the cathode 102.

3. Low Temperature Methane Conversion Device or CO₂ Conversion Device

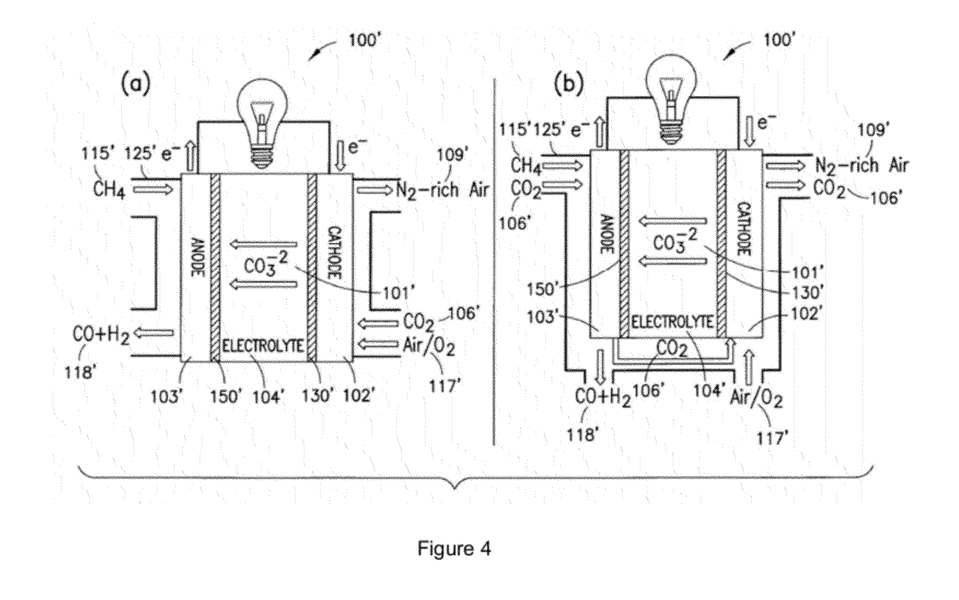

An exemplary embodiment of an electrochemical reactor 100′ which acts as a methane conversion device is disclosed herein. In general, exemplary electrochemical reactor 100′ utilizes the carbonate anion cycle to convert methane (e.g., natural gas) and/or methane/CO₂ mixtures from biogas to syngas at temperatures less than or about room temperature (e.g., at less than about 50° C.). With reference to FIG. 4(a), an exemplary device 100′ (e.g., methane conversion device 100′) is depicted. In exemplary embodiments, the methane conversion device 100′ operates by flowing a humidified mixture of O₂ (117′) and CO₂ (106′) to the cathode 102′ where the feed is reduced through a four electron process to CO₃⁻², which is shown by Equation 9 below:

½O₂+CO₂+2e⁻→CO₃⁻² (9)

The carbonate anions (101′) travel from the cathode 102′ to the anode 103′ through a humidified anion-conducting polymer membrane electrolyte 104′ (e.g., similar to polymer electrolyte 104 discussed above). Next, the carbonate anions react with methane (115′) at the anode (103), producing syngas (118′), which is illustrated by Equation 10 below:

CH₄+CO₃⁻²→CO+2H₂+CO₂+2e⁻ (10)

In exemplary embodiments, device 100′ includes a catalyst 150′ that is associated with the anode 103′ that adsorbs the carbonate anions 101′ produced at the cathode 102′ and oxidizes an incoming anode feed 125′ (e.g., methane and/or biogas) to produce syngas 118′ at low temperatures (e.g., at or below about 100° C., for example, at or below about 50° C. or about 40° C.). For example, catalyst 150′ may be a platinum based catalyst, or a composite material catalyst, such as a co-precipitated transition metal oxide:ZrO₂ composite catalyst or the like as described below (e.g., a MO:ZrO₂ electrocatalyst, such as a NiO/ZrO₂, CoO:ZrO₂ or a MnO:ZrO₂ electrocatalyst, or a Co₃O₄:ZrO₂ electrocatalyst or the like). Device 100′ also typically includes a catalyst 130′ (e.g., similar to cathode 130 discussed above) that is associated with the cathode 102′

One advantageous attribute for device 100′ is that the stoichiometry suggests an H₂:CO ratio slightly higher than 1, which is generally desirable for Fischer-Tropsch reactions to higher order organics (see, e.g., Choudhary, V. et al., Catal. Let., 32, 391 (1995)). Another advantageous feature for the disclosed electrochemical reactor 100′ is the overall consumption of CO₂ (106′), which may come from, e.g., the atmosphere, combustion waste streams and/or biogas.

With reference to FIG. 4(b), another exemplary electrochemical reactor 100′ flow setup is depicted. FIG. 4(b) depicts device 100′ having a flow setup that is designed to accommodate biogas (methane (115′) and CO₂ (106′)) or the like as the anode feed. Similar to FIG. 4(a), device 100′ in FIG. 4(b) operates by flowing a humidified mixture of O₂ (117′) and CO₂ (106′) to the cathode 102′ where the feed is reduced through a four electron process to CO₃⁻², which is shown by Equation 9 above. The carbonate anions travel from the cathode 102′ to the anode 103′ through a polymer membrane electrolyte 104′. Next, the carbonate anions react with methane (115′) at the anode (103′), thereby producing syngas (118′).

Thus, the total cell reaction for the room temperature electrochemical methane (or biogas) to syngas reactor/device 100′ may be depicted by Equation 11 as:

$${CH}_{4} + \frac{1}{2} {O}_{2} \to CO + 2 {H}_{2} , \\ {V}_{cell} = \frac{- Δ G}{n F} = 0.44 V \qquad ( 11 )$$

With respect to this total cell reaction, at least four items are notable. First, this process would not be possible in conventional systems due to the extremely high enthalpy of combustion of methane (115′) (e.g., about 800 kJ/mol). Second, only a small applied voltage (e.g., about 0.44 V) is necessary for this reaction to proceed at approximately 25° C., shown in Equation 11. For comparison, this is significantly lower than the voltage required for both water and CO₂ electrolysis for which the theoretical voltages are both approximately 1.2 V, although typical operating voltages are much greater than about 2.5 V (see, e.g., Whipple, D. T. et al., Prospects of CO₂ Utilization Via Direct Heterogeneous Electrochemical Reduction, The Journal of Physical Chemistry Letters, 1, 3451-3458 (2010)). Third, the cell voltage is positive in the exemplary process of the present disclosure, indicating that power is extracted from the cell, which is in contrast with other syngas synthesis methods. Fourth, in a conventional chemical system, CH₄ (115′) is weakly adsorbed, leading to low surface coverage and limited interaction with the catalyst material and adsorbed precursors and/or intermediates. In exemplary electrochemical cell 100′, the positive surface potential relative to the potential of zero charge decreases the free energy, thereby giving the catalyst surface a more electron-withdrawing character. Thus, when gas phase CH₄ (115′) approaches the catalyst of device 100′, partial electron transfer of a valence π electron from the C atom in methane (115′) to the catalyst is facilitated by a surface free energy shift, which increases the adsorption energy. This significantly increases the surface coverage of methane (115′) and creates opportunities for oxygen (117′) attack from CO₃⁻² (101′) due to weakened C—H bonding.

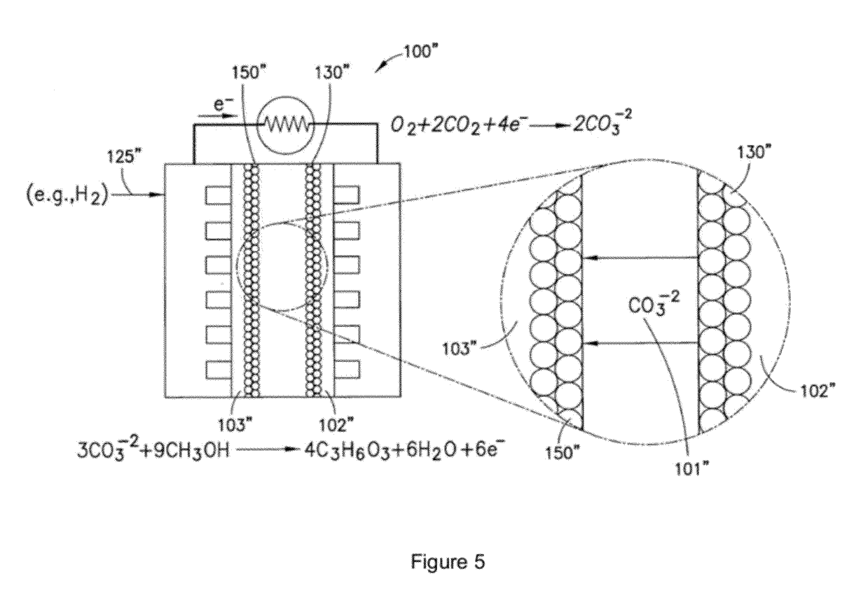

In another exemplary embodiment and as depicted in FIG. 5, a schematic diagram of a device 100″ is depicted. In general, device 100″ is adapted to function as a carbonate device 100″ for electrochemical conversion of CO₂ in another mode according to the present disclosure. Of note, FIG. 5 includes an exploded schematic view of the anionic membrane exchange within the disclosed device 100″. In such operating mode, a catalyst 150″ (e.g., a platinum based catalyst, or a composite material catalyst, such as a co-precipitated NiO/ZrO₂ composite catalyst or the like as described below) is selected at and/or associated with the anode 103″ that adsorbs the carbonate anions 101″ produced at the cathode 102″ and oxidizes an incoming anode feed 125″ (e.g., hydrogen or an alcohol or the like) to an industrially relevant product, such as, for example, dimethyl carbonate or formaldehyde. Thus, the disclosed electrochemical reactor 100″ is adapted to advantageously function in this mode as, inter alia, a room temperature (e.g., at less than about 50° C.) carbonate device 100″ for electrochemical conversion of CO₂. In general, device 100″ also typically includes a catalyst 130″ (e.g., similar to catalyst 130 discussed above) that is associated with the cathode 102″.

4. Room Temperature Carbonate Electrocatalyst

According to the present disclosure, an advantageous catalyst is provided that: (i) preferentially adsorbs CO₂ over H₂O at very low temperatures (<50° C.); (ii) catalytically activates the O═O bond; and (iii) has high electronic conductivity. The disclosed catalyst is generally tri-functional in nature and is a single compound. In exemplary implementations, the catalyst is an alkaline earth pyrochlore. However, beyond the exemplary alkaline earth pyrochlore catalyst disclosed herein, it is further contemplated that alternative chemistries as well as composites of two or more materials could be used to simultaneously achieve the three (3) advantageous properties and/or functionalities described above.

Pyrochlores generally have the structure A₂B₂O_{7-y}. The A and B sites may be individually controlled to tailor the catalytic properties of the disclosed catalyst, while the oxygen vacancy (y) gives the catalyst electronic conductivity. For example, alkaline earth metals (Ca, Mg, Ba and Sr) may be used at the ‘A’ site and high activity oxygen reduction reaction (ORR) catalysts in alkaline media (Ru, Pt, Ag, W) may be used at the ‘B’ site. In addition, the ‘A’ and/or ‘B’ sites may take the form of single components or combined components, e.g., the ‘A’ site could take the form of Ca_{0.5} and Ba_{1.5} and/or the ‘B’ site could take the form of RuPt. As will be readily apparent to persons skilled in the art, various combinations may be implemented at the ‘A’ and/or ‘B’ sites to achieve desired catalytic properties and performance.

An exemplary catalyst according to the present disclosure—Ca₂Ru₂O_{7-y}—generally works well with even about 1% CO₂ in the cathode stream. Mixed site materials, e.g., Ca_{1.5}Ba_{0.5}PtRu_{O7-y}, are also possible and logical extensions of the exemplary catalysts disclosed herein.

The ability to adsorb CO₂ over water is generally caused by the alkaline nature of the surface (CO₂ is a stronger Lewis acid than water). This gives the catalyst its high selectivity for the carbonate pathway (Equation 4 above) over the hydroxide pathway (Equation 3 above). The hydroxide pathway is typically preferred on all other known catalysts.

5. Experimentation Protocols

The following testing protocols were implemented to demonstrate that: i) alkali earth oxides with the pyrochlore structure (A₂B₂O₇) can selectively form carbonate anions in an alkaline electrochemical reactor; ii) operating the alkaline electrochemical reactor with carbonate anions reduces the degradation of state-of-the-art quaternary ammonium functionalized membranes compared with operation on the hydroxide cycle; and iii) H₂ and methanol can be electrochemically oxidized on Pt electrocatalysts by CO₃⁻².

In such experimentation, the selective electrochemical formation of carbonate anions may be accomplished using calcium-based alkaline earth oxide pyrochlores (Ca₂Ru₂O₇, Ca₂Pt₂O₇ and Ca₂W₂O₇) for the reduction of O₂ with CO₂. These oxides were selected based on the high surface basicity of raw alkaline earth oxides (such as CaO), which have been previously utilized in several applications (see, e.g., Fliatoura, K. D. et al., Selective Catalytic Reduction of Nitric Oxide by Methane in the Presence of Oxygen over CaO Catalyst, Journal of Catalysis, 183 (1999) 323; Hess, C. et al., NO₂ Storage and Reduction in Barium Oxide Supported on Magnesium Oxide Studied by in Situ Raman Spectroscopy, J. Phys. Chem. B., 107 (2003) 1982; Choudhary, V. R et al., Simultaneous Carbon Dioxide and Steam Reforming of Methane to Syngas over NiO—CaO Catalyst, Ind. Eng. Chem. Res., 35 (1996) 3934; Broqvist, P. et al., Toward a Realistic Description of NOx Storage in BaO: The Aspect of BaCO₃, J. Phys. Chem. B., 109 (2005) 9613; Xie, S. et al., Catalytic Reactions of NO over 0-7 mol% Ba/MgO Catalysts: II. Reduction with CH₄ and CO, Journal of Catalysis, 188 (1999) 32; Snis, A. et al., Catalytic Decomposition of N20 on CaO and MgO: Experiments and ab Initio Calculations, J. Phys. Chem. B., 102 (1998) 2555; Park, S. et al., Storage of NO₂ on potassium oxide co-loaded with barium oxide for NOx storage and reduction (NSR) catalysts, Journal of Molecular Catalysis A: Chemical, 273 (2007) 64; Reddy, C. et al, Room-Temperature Conversion of Soybean Oil and Poultry Fat to Biodiesel Catalyzed by Nanocrystalline Calcium Oxides, Energy & Fuels, 20 (2006) 1310; Yan, S. et al., Supported CaO Catalysts Used in the Transesterification of Rapeseed Oil for the Purpose of Biodiesel Production, Energy & Fuels, 22 (2008) 646; Liu, X. et al., Transesterification of soybean oil to biodiesel using CaO as a solid base catalyst, Fuel, 87 (2008) 216; Gryglewicz, S., Alkaline-earth metal compounds as alcoholysis catalysts for ester oils synthesis, Applied Catalysis A: General, 192 (2000) 23; Dissanayake, D. et al., Oxidative Coupling of Methane over Oxide-Supported Barium Catalysts, Journal of Catalysis, 143 (1993) 286; Wang, Y. et al., Effective Catalysts for Conversion of Methane to Ethane and Ethylene Using Carbon Dioxide, Chemistry Letters, (1998) 1209; Wang, H. et al., CaO—ZrO₂ Solid Solution: A Highly Stable Catalyst for the Synthesis of Dimethyl Carbonate from Propylene Carbonate and Methanol, Catalysis Letters, 105 (2005) 253; Liu, Z. et al., Effect of basic properties of MgO on the heterogeneous synthesis of flavanone, Applied Catalysis A: General, 302 (2006) 232; Wang, H. et al., Influence of preparation methods on the structure and performance of CaO—ZrO2 catalyst for the synthesis of dimethyl carbonate via transesterification, Journal of Molecular Catalysis A: Chemical, 258 (2006) 308; Breysse; E. et al., Addition of hydrogen sulfide to methyl acrylate over solid basic catalysts, Journal of Catalysis, 233 (2005) 288; Bhanage, B. et al., Synthesis of dimethyl carbonate and glycols from carbon dioxide, epoxides, and methanol using heterogeneous basic metal oxide catalysts with high activity and selectivity, Applied Catalysis A: General, 219 (2001) 259; Choudhary, V. et al., Epoxidation of styrene by TBHP to styrene oxide using barium oxide as a highly active/selective and reusable solid catalyst, Green Chemistry, 8 (2006) 689; Marino, F. et al., Supported base metal catalysts for the preferential oxidation of carbon monoxide in the presence of excess hydrogen (PROX), Applied Catalysis B: Environmental, 58 (20050 175; Jimenez, R. et al., Soot combustion with KlMgO as catalyst: II Effect of K-precursor, Applied Catalysis A: General, 314 (2006) 81; Tarnai, T. et al., Dichlorodifluoromethane Decomposition to CO2 with Simultaneous Halogen Fixation by Calcium Oxide Based Materials, Environ. Sci. Technol., 40 (2006) 823; McCaffrey, E. F. et al., Kinetic studies of the catalytic activity of alkaline earth oxides in 2-propanol decomposition, 1. Phys. Chem., 76 (1972) 3372; and Catlow, C. et al., Computation Studies of Solid Oxidation Catalysts, 1. Phys. Chem., 94 (1990) 7889) as well as the ability for Pt, Ru and W to electrochemically activate the O═O bond in alkaline media (see, e.g., Munenaka, T. et al., A Novel Pyrochlore Ruthenate: Ca2Ru207, Journal of the Physical Society of Japan, 75 (2006) 103801; Horowitz, H. S. et al., New oxide pyrochlores: A2[B2-xAx]07-y(A=Pb, Bi; B=Ru, Ir), Mat. Res. Bull., 16 (1981) 489; Horowitz, H. S. et al., Oxygen Electrocatalysis on Some Oxide Pyrochlores, Journal of the Electrochemical Society, 130 (1983) 1851; Widelov, A. et al., Electrochemical and Surface Spectroscopic Studies of Thin Films of Bismuth Ruthenium Oxide (Bi2Ru207), Journal of the Electrochemical Society, 143 (1996) 3504; Kohoul, A. et al., A Sol-Gel Route for the Synthesis of Bi2Ru207 Pyrochlore Oxide for Oxygen Reaction in Alkaline Medium, Journal of Solid State Chemistry, 161 (2001) 379; Prakash, J. et al., Investigations of ruthenium pyrochlores as bifunctional oxygen electrodes, Journal of Applied Electrochemistry, 29 (1999) 1463; and Prakash, J. et al., Kinetic Investigations of Oxygen Reduction and Evolution Reactions on Lead Ruthenate Catalysts, Journal of the Electrochemical Society, 146 (1999) 4145). The high surface basicity of the Ca₂M₂O₇ pyrochlores was expected to lead to preferred adsorption of CO₂ over H₂O, which was observed by Fliatoura and co-workers for the conversion of NO on CaO (see, e.g., Fliatoura, K. D. et al., Selective Catalytic Reduction of Nitric Oxide by Methane in the Presence of Oxygen over CaO Catalyst, Journal of Catalysis, 183 (1999) 323). This preferred adsorption of CO₂ was expected to encourage the reaction to occur preferentially through the “direct” pathway, yielding a high selectivity electrocatalyst.

At the anode (e.g., anode 103 of FIG. 2), Pt was employed for the electrochemical oxidation of hydrogen and methanol by carbonate ions. Improved stability and ionic conductivity of anion exchange polymer membranes may also be shown using commercially available films. It was further contemplated that these components will also be combined to construct and demonstrate the operation of a 5 cm² reactor.

Three methods were studied to synthesize pyrochlore-structured calcium ruthenium oxides. Method 1 involved high temperature solid-state reaction of oxide salts and both Method 2 and Method 3 were low temperature hydrothermal routes.

In Method 1, CaO (Reagent Grade) and RuO₂ reaction precursors were used. RuO₂ was synthesized in-house by heating RuCl₃ (ReagentPlus) at about 800° C. in air for about six (6) hours. Calcium oxide and ruthenium oxide were mixed and ground with a mortar and pestle in approximately a 2:1 mol ratio (Ca:Ru). The mixed salts were formed into about 13 mm diameter pellets using a pellet dye and press (Carver, Inc). Subsequently, the pellet was heat treated in air to several temperatures between about 100° C. and 1100° C.

Method 2 was a modification of the hydrothermal route developed by Horowitz and coworkers for the synthesis of lead ruthenate pyrochlores (see, e.g., Horowitz, H. S. et al., Mater. Res. Bull., 16, 489 (1981)). Here, KOH (ACS reagent grade) was dissolved in 18MS) Millipore water to make about 1M, 0.1M and 0.01M solutions. Subsequently, CaO and RuCl₃ were added in various Ca:Ru molar ratios and stirred vigorously for approximately 20 minutes. The solution was heated between about 55° C. and 95° C. while oxygen was bubbled for about 24-72 hours. The precipitate was filtered, washed with deionized water several times and dried overnight at about 80° C.

In Method 3, KMnO₄ was used as a replacement for oxygen in the hydrothermal synthesis. Using KMnO₄ allowed the solution to be refluxed at elevated temperatures while also providing a more strongly oxidizing environment than dissolved O₂. About 1M KOH solutions was prepared using Millipore water. About 1 mM and 10 mM potassium permangante solutions were prepared by adding KMnO₄ to the 1M KOH solutions. CaO and RuCl₃ were solvated in approximately a 1:1 molar ratio and thoroughly mixed at about 80° C. for around 20 minutes. Then, the solution was heated to about 200° C. and maintained isothermally under reflux for about 12 to 120 hours. The resulting precipitate was filtered, washed with deionized water and dried overnight at about 80° C.

Products obtained by all synthesis methods were characterized using XRD. XRD patterns were obtained by scanning from about 10° to 90° (20) at a scan rate of approximately 2°/min in a Bruker D8 advance diffractometer (Cu—Kα radiation, λ=0.15418 nm). A Micromeritics ASAP 2020 system was used to collect N₂ adsorption/desorption data at about 77 K. To remove adsorbed impurities prior to experimentation, the sample was degassed at about 200° C. and about 10 μmHg for approximately ten (10) hours. The BET specific surface area was calculated using the N₂ adsorption isotherm between relative pressures (P/Pₒ) of about 0.002 and about 0.05. SEM images were taken using a FEI Strata 400 s SEM.

Temperature programmed desorption (TPD) was performed by placing approximately 100 mg of the calcium ruthenate pyrochlore or platinum supported on carbon (10% Pt/C, BASF) in a Thermolyne 79300 tube furnace (ThermoFisher). All gases used were ultra high purity (Airgas). Prior to each experiment, the furnace tube (25 mL) was purged with 20 mL/min dry helium for about two (2) hours and the sample was pretreated by heating to about 500° C. Background TPD was obtained by heating from about 25° C. to 1000° C. at a rate of approximately 5° C./min while continuously purging with He. The effluent from the tube furnace was continuously analyzed with a QMS100 mass spectrometer (Stanford Research Systems). Afterwards, the sample was exposed to CO₂ or humidified He for about two (2) hours followed by purging with dry He for about two (2) hours. Finally, the sample was heated from about 25° C. to 1000° C. at a rate of approximately 5° C./min while continuously purging with He and analyzing the effluent from the tube furnace using the QMS-100.

Fuel cell experiments were carried out with a Scribner 850e Fuel Cell Test Station. Humidified hydrogen and nitrogen were used as the anode gases, while humidified oxygen and carbon dioxide mixtures were used as the cathode feed. All gases were ultra high purity and obtained from Airgas. Experiments were carried out at a cell temperature of about 50° C. Catalyst inks were prepared by suspending in dimethylformamide (DMF) either commercial 10% Pt/C (BASF) or NiO nanoparticles synthesized using a room-temperature NaOH-induced precipitation method described elsewhere for the anode (see, e.g., Spinner, N. et al., Electrochim. Acta, 56, 5656 (2011)), and the Ca₂Ru₂O_{7-y} pyrochlore prepared using synthesis Method 3, described above with respect to the cathode (e.g., cathode 102 of FIG. 2). The catalyst ink was painted on 5 cm² Toray carbon paper to a total catalyst loading of 1 mg/cm² at the anode and 3 mg/cm² at the cathode. It should be noted that no anionomer was added to the catalyst ink, which led to low cell performance due to limited electrochemically active area. A Ralex AM-PAD (Mega a.s.) anion exchange membrane (e.g., polymer electrolyte 104 of FIG. 2) was used as an electrolyte to prepare the membrane electrode assembly (MEA). The membrane was exchanged from its chloride to hydroxide or carbonate form by soaking in 1M KOH or 1M Na₂CO₃ solution, respectively, for 24 hours. The MEA was loaded into standard 5 cm² fuel cell hardware and humidified overnight prior to experimentation. Mass spectra of the anode effluent were collected with a QMS 100 Series Gas Analyzer (Stanford Research Systems).

Ex-situ electrochemical experiments were carried out by depositing a thin film of the Ca₂Ru₂O_{7-y} pyrochlore on a 5 mm diameter glassy carbon (GC) rotating disk electrode (RDE). Thin-film working electrodes were prepared using a sonicated suspension of the Ca₂Ru₂O_{7-y} pyrochlore in water (0.3 mg/mL). 20 μL of the suspension was placed on the GC electrode and dried, followed by the addition and drying of 20 μL of 100× diluted Nation DE520 dispersion. A platinum foil several times larger than the working electrode was used as the counter electrode. A saturated calomel electrode (SCE) was used as the reference electrode and all potentials are reported with respect to the SCE. The 1M KOH electrolyte was prepared by dissolving reagent grade KOH pellets in 18 MΩ Millipore deionized (DI) water.

Linear sweep voltammetry experiments were conducted in a custom-built three compartment jacketed glass cell (Adams & Chittenden Scientific Glass) with a Luggin capillary. The counter electrode was separated from the working electrode by a fitted glass separator. All electrodes were rinsed with DI water and fresh electrolyte before experimentation. Prior to experimentation, the electrolyte was purged with N₂ for about one (1) hour, followed by about one (1) hour of O₂ bubbling to ensure saturation. All experiments were thermostated at about 25±0.1° C. Polarization and cyclic voltammetry (CV) data was collected with an Autolab PGSTAT302N potentiostat. The RDE rotation speed was controlled with an AFMSRCE analytical rotator (Pine Instrument Company).

a. Carbonate Selective Oxygen Reduction Catalysts

The alkaline earth pyrochlores (AEPs) were prepared and characterized via a hydrothermal route with single phases of the raw alkaline earth oxide (CaO) and “B” metal oxide particles (see, e.g., Munenaka, T. et al., A Novel Pyrochlore Ruthenate: Ca2Ru207, Journal of the Physical Society of Japan, 75 (2006) 103801). The approximate elemental composition of the resulting catalysts was estimated using a cold cathode field emission scanning electron microscope with an integrated energy dispersive X-ray spectrometer (EDS). Phase identification and nanoparticle size was measured using XRD. Surface chemistry and bond formation analysis was determined by XPS.

The electrocatalytic activity of the resulting electrocatalysts, as well as their selectivity for the “direct” carbonate pathway, will be elucidated below in discussion of the experimentation results. The electrochemical experiments were executed in a custom-built three electrode electrochemical cell with a Luggin capillary. Here, the AEPs were deposited as a thin film electrode onto a 5 mm diameter glassy carbon disk-type working electrode. A Pt foil was used as the counter electrode and an Hg/HgO alkaline electrode was used as a reference. All electrochemical measurements were made with an Autolab PGSTAT302N potentiostat.

The electrochemical stability and passivation resistance of the catalysts were investigated in N₂-saturated 0.1 M KOH and 0.1 M Na₂CO₃/NaHCO₃ aqueous electrolytes using cyclic voltammetry. Voltammograms were obtained by cycling the working electrode potential several times between about −0.8 and 0.62 V vs. NHE. The activity of the AEP catalysts toward the hydroxide pathway can be elucidated using rotating disk type electrodes (RDE) immersed in O₂ saturated KOH solutions. The RDE system was ideal because of its well defined hydrodynamics, which are controlled by the electrode rotation rate. This allowed a subtraction of mass transfer effects from experimental data, yielding pure kinetic information. Here, slow scan, about 1 mV/s, voltammograms were collected at electrode rotation rates of approximately 400, 900, 1600 and 2500 RPM at about 25° C. between approximately −0.4 and 0.6 V vs. NHE. Due to the difficulty in determining the electrochemical carbonate formation in water, activity of the AEO electrocatalyst was also collected in O₂/CO₂ saturated acetonitrile electrolytes with 0.1 M NaHCO₃/Na₂CO₃. In dry acetonitrile, reduction of O₂ occurred exclusively with CO₂ through the carbonate pathway.

b. Stability and Ionic Transport of Polymer Electrolytes

Several high ion exchange capacity (>1.0 meq/g) anion exchange membranes are commercially available. Six such membranes were selected for this experimentation: MA-3475 from Sybron Chemicals, AMI-7001 from Membranes International, Ralex AMH-PAD from Mega AS, Neosepta from Alstom, AMB-SS from Resin Tech, and Tokuyama A006 from Acta Nanotech. All of the listed commercially available films were delivered in their chloride form. Therefore, the first step in electrolyte preparation was to convert the membrane to either its hydroxide or carbonate form by ion exchange in either 0.1 M KOH or 0.1 M Na₂CO₃ for about 24 hours. Conversion to the hydroxide and carbonate forms was confirmed by FTIR. Then, the ion exchanged films were soaked in 1.0 M OH⁻,10⁻⁴ M OH⁻ or 1.0M Na₂CO₃/1.0M NaHCO₃. Film samples were extracted after about 1, 2, 5, 10, 20 and 30 days in order to observe the change in bonding over time. Active sites undergoing nucleophillic attack showed a decrease in the N—C bond stretch at around 1200 cm⁻¹. It was further contemplated that because the nitrogen valence was lowered, a positive shift in wave number would also be observed. For films undergoing the Hoffman elimination, an increased C═C bond peak around 1650 cm⁻¹ was expected.

As membrane degradation progressed, the ionic conductivity of the resulting electrolyte was expected to decrease due to the elimination of ion exchange sites within the polymer film. In this experimentation, the ionic conductivity of the polymer films was determined under fully humidified conditions by placing the membrane in a custom two compartment conductivity cell with fixed electrode areas and separation. The conductivity was determined by electrochemical impedance spectroscopy immediately following ion exchange and then at identical time intervals to the FTIR experiments.

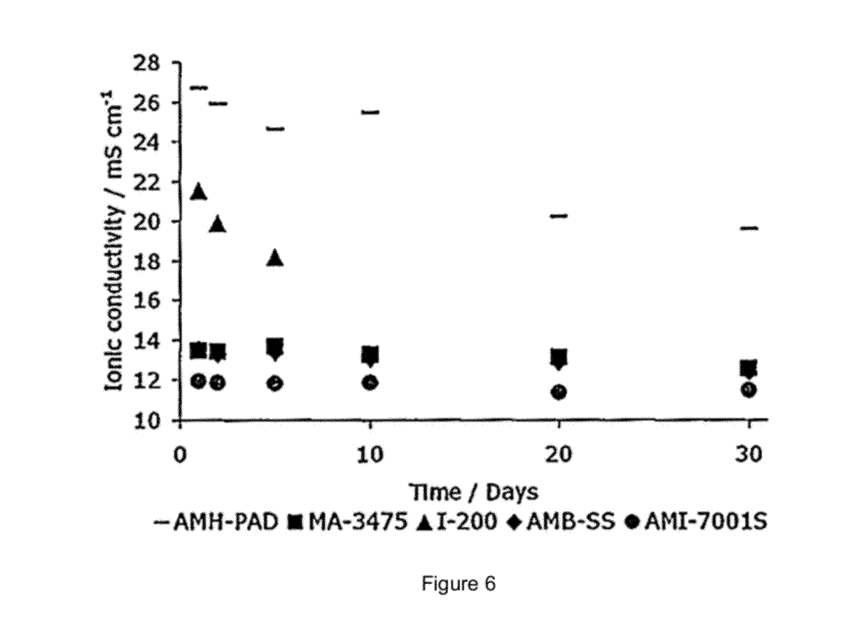

With reference to FIG. 6, plot of ionic conductivity (mS cm⁻¹) vs. time (days) are provided for five (5) fuel cell systems which are designated as follows: AMH-PAD, MA-3475, I-200, AMB-SS and AMI-7001 S. As is apparent from the data plotted in FIG. 6, the AMH-PAD system exhibits superior ionic conductivity levels over an extended period relative to the other membrane systems.

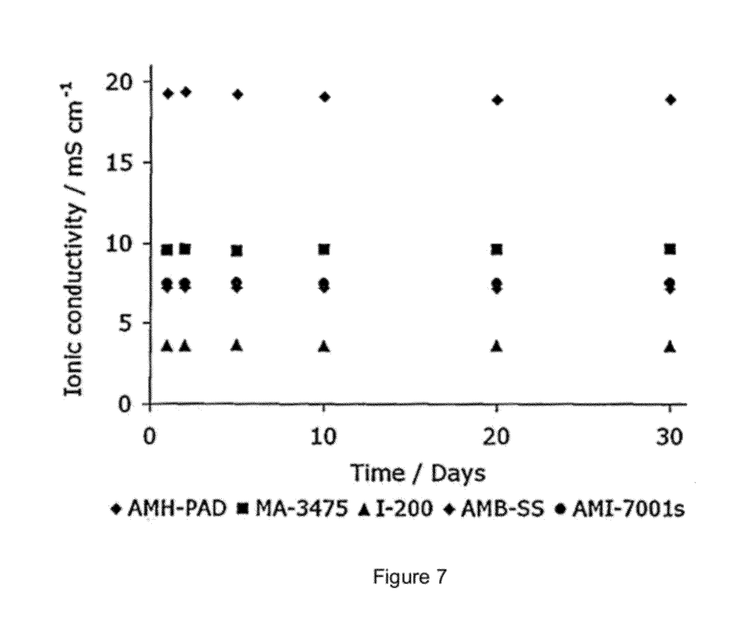

Now with reference to FIG. 7, a plot of ionic conductivity (mS cm⁻¹) vs. time (days) is provided for the five (5) fuel systems identified above with reference to FIG. 6. The AMH-PAD system again exhibits superior ionic conductivity over time relative to the other systems reflected therein.

c. Hydrogen and Methanol Oxidation with Carbonate Anions

The adsorption of carbonate anions was expected to proceed without obstacle on metallic surfaces; however, not all surfaces have the ability to readily facilitate C—O bond cleavage and show sufficiently high oxygen surface mobility. These are critical properties for methanol oxidation catalysts in the presence of carbonate and, thus, candidate catalysts were chosen with these as the primary design criteria: Pt, PtRu, Raney Ni and NiO. Further, the oxidation of H₂ and CH₃OH with CO₃⁻² on Pt was investigated. Pt was selected from the candidates due to its bonding, surface chemistry and electrochemical activity being the best understood and documented among the candidates, providing a reliable point for comparison. The experimental setup for electrochemical characterization of Pt is identical to the one that was used for the cathode studies. A polished 5 mm diameter Pt disk working electrode (Pine Instrument Company) was utilized. All anode characterization experiments were conducted in 0.1 M NaHCO₃/0.1 M Na₂CO₃ and 10⁻⁴ M KOH/0.25M NaClO₄ aqueous alkaline electrolytes thermostated at about 25° C. in the custom built three electrode cell. Hydrogen was introduced to the system by bubbling H₂ across the working electrode and methanol (0.5 M) was directly mixed in the electrolyte. The data from both dilute hydroxide and concentrated carbonate solutions was combined to yield an accurate description of the oxidation activity with carbonate.

d. Room Temperature Carbonate Fuel Cell

To show that these studies lead to the development of an electrochemical reactor that operates with high efficiency and is at the very least competitive with current state-of-the-art HEMFC and PEMFC in terms of both performance and cost, a 5 cm² cell was constructed and electrochemically characterized. Electrochemical measurements were conducted with a Scribner and Associates fuel cell test station with an 850E load box. Linear sweep polarization between the open circuit voltage (OCV) and about 0.2 V provided a baseline performance curve and high throughput technique to characterize these laboratory scale cells. Then, chronoamperometric experiments were used in order to obtain steady state polarization measurements at about 10 mV intervals between the OCV and about 0.2 V, which gave a more accurate representation of the true performance of the fuel cell under various loads. Chronoamperometry performed at about 0.6 V was used in order to observe the performance stability of the electrochemical reactor. Finally, electrochemical impedance spectroscopy was used in this experimentation in order to determine the Ohmic and charge transfer resistances for the electrolyte and electrocatalysts, respectively, between about 25 and 80° C.

e. Low Temperature Methane Conversion Device or Co₂ Conversion Device

In testing the exemplary methane conversion devices or CO₂ conversion devices, several device configurations will be implemented. For example and as similarly depicted in FIG. 4(a), humidified CH₄ (115′) and O₂/CO₂ (117′ and 106′) will be fed to the anode 103′ and the cathode 102′ compartments, respectively. Polarization curves will be collected by linear sweep voltammetry (LSV) between the open circuit voltage (OCV) and about −1.0 V at about 10 mV/s. Without being bound by any theory, it is believed that these polarization curves will provide baseline performance and a high throughput technique to characterize the catalyst activity in situ. In these experiments, the cell temperature will be varied between about 25-40° C. and the relative humidity will be adjusted between about 30-95%. To measure the steady state catalyst selectivity and performance stability, chronoamperometric experiments will be performed approximately every 100 mV between the OCV and around −1.0 V. The anode effluent will be fed to a GC/MS to determine the effluent composition. Relative increases in the partial pressures for methanol and CO₂ at operating conditions versus OCV, i.e., zero current, will be tied directly to the electrochemical current for straightforward determination of the steady state selectivity as a function of the electrode potential. Further, AC impedance will be used to decouple the internal resistances of the cell and identify areas where further reactor improvement may be needed. The AC frequency will be varied between approximately 0.1 Hz and 1 MHz, and experiments will be conducted at around 100 mV intervals between the OCV and about −1.0 V.

In another proposed exemplary configuration (e.g., as similarly illustrated in FIG. 4(b)), the anode feed composition will be varied between about 50:50 to about 75:25 CH₄:CO₂ to simulate common biogas feeds. Without being bound by any theory, utilizing biogas feeds may be of particular interest for implementation with the exemplary reactor since CO₂ is generally reduced to carbonate at the cathode, which then acts as the oxygen source for the partial oxidation of methane to methanol at the anode. Therefore, direct feeding of biogas to the reactor typically eliminates the need for an external CO₂ source and thereby may simplify the balance of plants (e.g., water management systems, thermal management, gas flow and distribution, pumps, compressors, etc.), thereby reducing cost. It is believed that experiments using simulated biogas of varied composition will help determine the sensitivity of the exemplary reactor to the inlet feed. Moreover, LSV, CA, and AC impedance will be used to study these effects on, e.g., catalyst activity, stability and selectivity. Further, the exemplary reactor will be run substantially identical to the configuration depicted in FIG. 4(b), wherein the anode effluent was run through a condenser to collect the liquid product, mixed with humidified oxygen and fed to the cathode.

5. Experimental Results

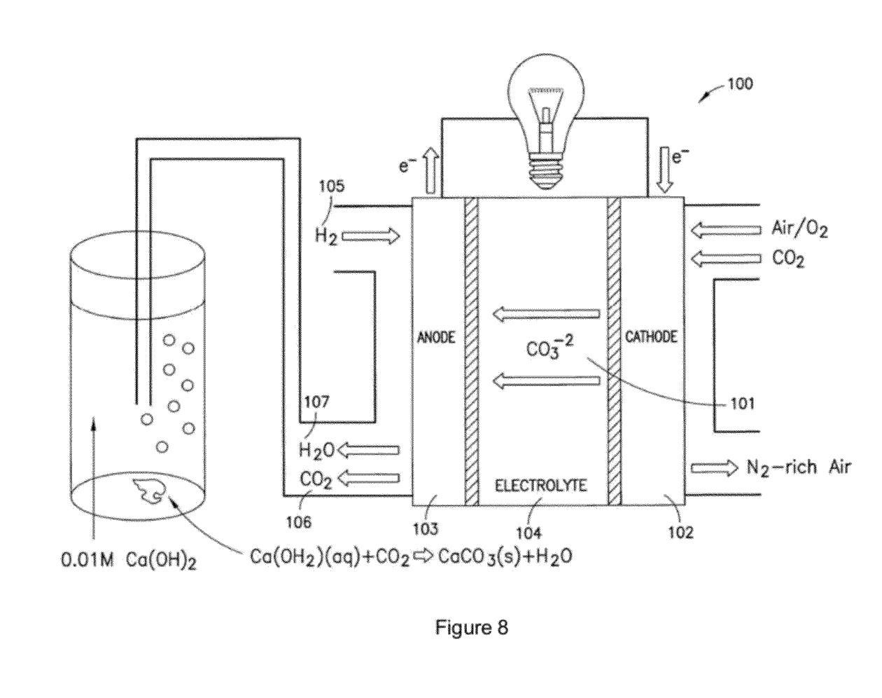

With reference to the above-described experimental studies, experimentation results with respect to the disclosed electrochemical reactor device and electrocatalyst of the present disclosure have been obtained and are set forth in FIGS. 8-27.

a. Verification of the Carbonate Cycle

In this experimentation, analysis of the anode effluent was used to confirm operation on the carbonate cycle. There are three main routes through which CO₂ may be present in the anode exhaust. First, diffusional crossover through the electrolyte could happen due to the CO₂ concentration gradient between the cathode and anode. The extent of CO₂ crossover through this path can be easily measured by imposing a concentration gradient between the two electrodes, maintaining the cell at open circuit voltage (OCV) and confirming the presence of CO₂ at the anode. Second, during FC operation, the presence of CO₂ at the cathode and its contact with the electrolyte can lead to the formation of carbonate anions by thermodynamic equilibrium between water, hydroxide, bicarbonate and carbonate, as was discussed with respect to Equations 3-4 above. This “indirect route” or “hydroxide route” for carbonate formation would be the primary source of carbonate anions for operation with a non-carbonate selective cathode catalyst. Third, carbonate can be electrochemically formed at the cathode by “direct route” electroreduction of O₂ and CO₂, as was discussed with respect to Equations 1-2 above. For both the direct and indirect pathways, the resulting carbonate anions carry the charge from cathode to anode where they oxidize H₂ by Equation 6.

Recent work has suggested that conventional Pt catalysts can produce some CO₃⁻² anions through the direct pathway when CO₂ is added to the AEMFC cathode feed (see, e.g., Vega, J. A. et al., Electrochim. Acta, 55, 1638 (2010); Unlu, M. et al., Electrochem. Solid State, 12, B27 (2009); and Lang, C. M. et al., Electrochem. Solid State, 9, A545 (2006)). However, Pt shows quite low selectivity for the direct carbonate pathway and much of the carbonate production with Pt catalysts occurs through the indirect route. This has been previously confirmed where partial carbonation of the membrane electrolyte occurs independent of operating conditions (see, e.g., Siroma, Z. et al., Electrochem. Soc., 158, B682 (2011); Kizewski, J. et al., ECS Trans., 33, 27 (2010); and Watanebe, S. et al., ECS Trans., 33, 1837 (2010)). The nature of these two pathways suggests that the quantity of CO₂ measured in the anode effluent with a carbonate selective catalyst is notably higher than a cell operating with Pt at the cathode. Unfortunately, quantifying the contribution of each pathway has proven difficult and a reliable method to accomplish this is yet to be reported in the prior art, and is not attempted here.

Production of CO₂ at the anode electrode was first confirmed by flowing the anode effluent through a 0.01 M calcium hydroxide solution while performing chronopotentiometric (CE) experiments at about 1 mA/cm² for approximately two (2) hours using a Pt/C anode. FIG. 8 provides a representation of the CE experimentation set-up using constant current operation to show carbonate cycle selectivity. The presence of CO₂ in the effluent was verified by the precipitation of calcium carbonate through Equation 12, shown below, which is highly insoluble in alkaline media.

Ca(OH)₂+CO₂→CaCO₃+H₂O (12)

Before each experiment, the cell was flushed with reaction gases for about 30 minutes to ensure the anode compartment was free of ambient carbon dioxide. The cell was left at open circuit with H₂ as the anode feed and O₂/5% CO₂ as the cathode feed. In this case, no CaCO₃ precipitate was observed during the approximately two (2) hour experiment time, which indicated negligible CO₂ diffusional crossover through the membrane.

Next, CE experiments using H₂ as a fuel, coupled with CaCO₃ precipitation, were performed. The following four experiments were performed, varying the exchanged membrane anion and the cathode feed: (1) membrane exchanged to OH⁻, O₂ cathode feed and Pt/C as cathode catalyst; (2) membrane exchanged to CO₃²⁻, O₂ cathode feed and Pt/C as cathode catalyst; (3) membrane exchanged to CO₃²⁻, O₂/CO₂ cathode feed and Pt/C as cathode catalyst; (4) membrane exchanged to CO₃²⁻, O₂/CO₂ cathode feed and Ca₂Ru₂O_{7-y} as cathode catalyst. The variations of exchanged membrane anion and cathode feed for the four experiments is summarized in Table 1 below:

TABLE 1
Cathode feed and exchanged AEM anion for precipitation experiments

| Experiment | Anode feed^{a} | Cathode feed^{a, b} | Exchanged AEM anion |
|---|---|---|---|
| 1 | H₂ | O₂ | OH⁻ |
| 2 | H₂ | O₂ | CO₃²⁻ |
| 3 | H₂ | O₂ + CO₂ | CO₃²⁻ |
| 4 | H₂ | O₂ + CO₂ | CO₃²⁻ |

^{a}All feeds were humidified
^{b}CO₂ content was 5%

For Experiment 1, as expected, no CaCO₃ precipitation was observed, demonstrating operation on the hydroxide cycle. During Experiment 2, initial precipitation of CaCO₃ was observed. However, the precipitation slowed with time and completely stopped after approximately 30 minutes of operation and no further precipitation was observed for the remainder of the experiment. This demonstrated that the carbonate initially present in the membrane was able to carry the charge through the electrolyte and subsequently consumed at the anode through H₂ oxidation (Equation 6). During this time, CO₃⁻² was slowly flushed and the membrane was exchanged to its hydroxide form while operating on the hydroxide cycle. For Experiments 3 and 4, CaCO₃ precipitation was observed throughout the experiment, which confirmed the continuous production of carbonate. For these experiments, the amount of the charge carried by carbonate was estimated by drying and weighing the CaCO₃ precipitate after each experiment.

For the CE experiments, the theoretical quantity of CO₂ that should be formed at the anode assuming 100% operation on the carbonate cycle is described by Equation 13 below:

$${N}_{{CO}_{2} , {t}_{k}} = {N}_{{CO}_{3 - 2}} = {\int }_{{t}_{o}}^{{t}_{f}} \frac{i ( t )}{n F} d t = \frac{i Δ t}{2 F} \qquad ( 13 )$$

where i is the current, t is the time, n is the electron equivalence and F is Faraday's constant. Meanwhile, the number of moles of CO₂ produced during the CE experiments can be calculated by Equation 14 below:

$${N}_{{CO}_{2} , meas} = \frac{{M}_{{CaCO}_{3}}}{M {W}_{{CaCO}_{3}}} \qquad ( 14 )$$

where M_{CaCO3} is the measured mass of precipitated CaCO₃ and MW_{CaCO3} is its molecular weight. Finally, the selectivity for carbonate formation can be defined as the portion of charge carried by CO3⁻² divided by the portion of charge carried by OH⁻, which can be calculated for both catalysts using Equation 15 below:

$$S = \frac{\frac{{N}_{meas}}{{N}_{th}}}{1 - ( {N}_{meas} / {N}_{th} )} \qquad ( 15 )$$

After each CE experiment, the CaCO₃ precipitate was dried at about 100° C. overnight before its mass was measured. Table 2 below shows the results obtained with both Pt/C and Ca₂Ru₂O_{7-y} cathode catalysts.

TABLE 2
Selectivity of Pt/c and Ca₂Ru₂O_{7-y}

| Catalyst | % Theoretical CO₂ | Selectivity |
|---|---|---|
| Pt/C | 64 | 1.78 |
| Ca₂Ru₂O_{7-y} | 88 | 7.33 |

The results of Table 2 depict that more CO₂ was evolved from the anode when Ca₂Ru₂O_{7-y} was used as the cathode catalyst, which suggests the preferential formation of carbonate on this catalyst compared with Pt/C. The calculated selectivity for Pt/C was about 1.78, while for Ca₂Ru₂O_{7-y}, the selectivity was about 7.33. This amounted to an approximately 4.1 times increase in carbonate selectivity using Ca₂Ru₂O_{7-y} compared to Pt/C, which was most likely a product of increased adsorption of CO₂ versus H₂O on Ca₂Ru₂O_{2-y} that was facilitated by its high surface basicity.

One obvious limitation to this selectivity calculation is in its inability to distinguish contributions of the direct and indirect pathway. This is particularly important for the Pt catalyst as it is likely that a large portion of the effluent CO₂ was a product of the indirect route (see, e.g., Kizewski, J. et al., ECS Trans., 33, 27 (2010)). Thus, the selectivity gain in Table 2 is likely much lower than its true value. Despite this limitation, it is clear that a significantly larger percentage of CO₃⁻² was formed by the direct pathway when Ca₂Ru₂O_{7-y} was employed at the cathode. However, the development of new experimental protocols that can deconvolute the contributions of the direct and indirect pathway would assist in truly quantifying this effect.

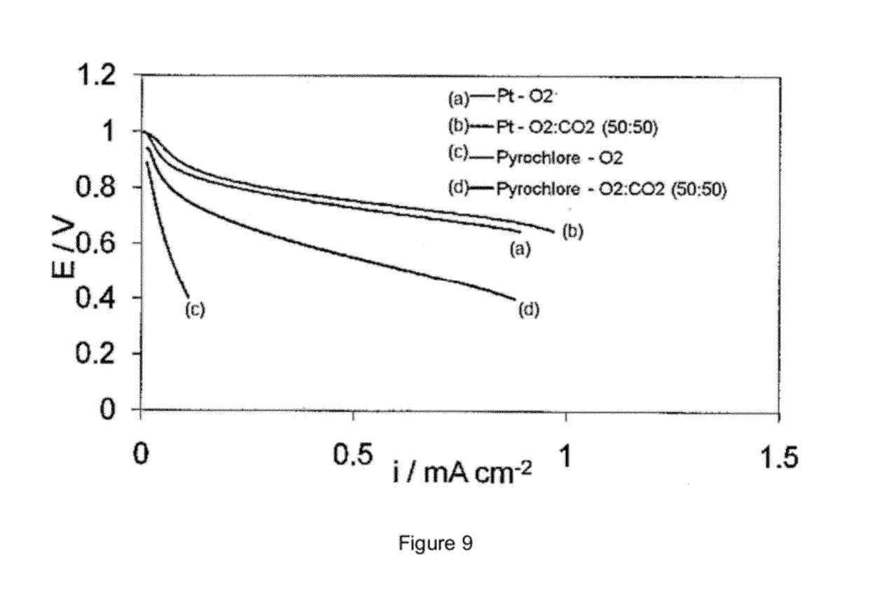

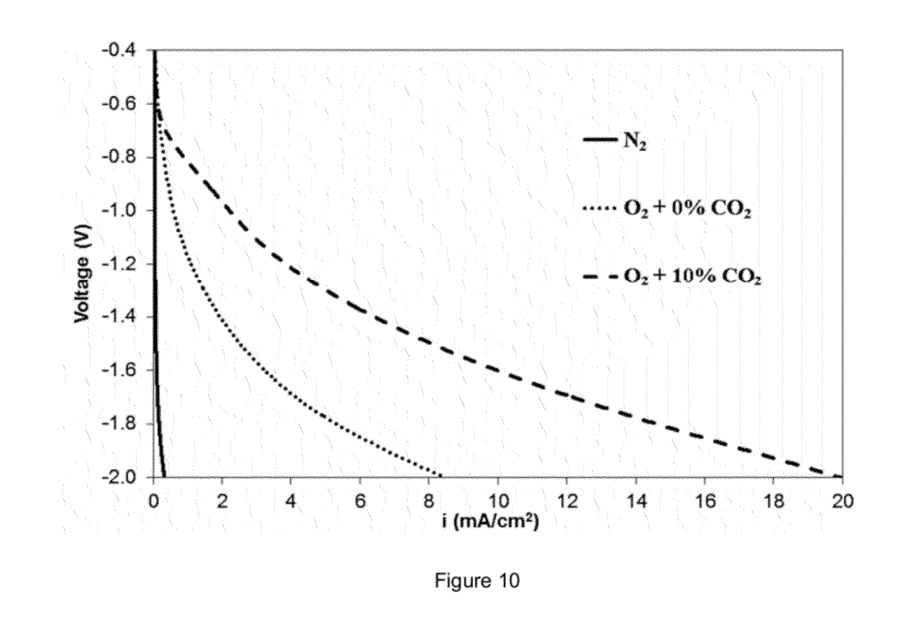

Further, operation on the carbonate cycle was also confirmed by constructing cells with Ca₂Ru₂O_{7-y} at the cathode and a carbonate electrolyzing catalyst, NiO, at the anode. With reference to FIG. 9, preliminary results are demonstrated for cathode selectivity for carbonate formation using an exemplary pyrochlore catalyst—Ca₂Ru₂O_{7-y}—in various O₂/CO₂ environments according to the present disclosure. Further, with reference to FIG. 8, polarization curves are shown collected at about 50 mV/s between OCV and about −2V with humidified N₂ used as the anode stream and several different cathode streams. First, N₂ at both anode and cathode streams was used as a reference to show the lack of any significant electrochemical activity when no oxidant was supplied to the cathode. However, there was a clear current increase when O₂ was supplied at the cathode. As can be seen in FIG. 10, with O₂ in the cathode stream, a significant increase in current was observed after CO₂ addition. With 10% CO₂, the maximum current density was about 2.3 times greater than without CO₂, reaching a value of approximately 19.9 mA/cm² at −2V. Since no fuel oxidation reaction is happening at the N₂ containing anode, the increase in performance was likely due to enhanced ORR activity for the carbonate cycle versus hydroxide on Ca₂Ru₂O_{7-y} at the cathode and the electrolysis of the resulting hydroxide, Equation 16, or carbonate anion, Equation 17, at the anode.

4OH⁻_{(aq)}→O_{2(g)}+H₂O+4e⁻ (16)

2CO_{3 (aq)}⁻²→O_{2(g)}+2CO_{2(g)}+4e⁻ (17)

In turn, the increase in performance with the presence of CO₂ at the cathode suggests enhanced kinetic performance and the preferential formation of carbonate.

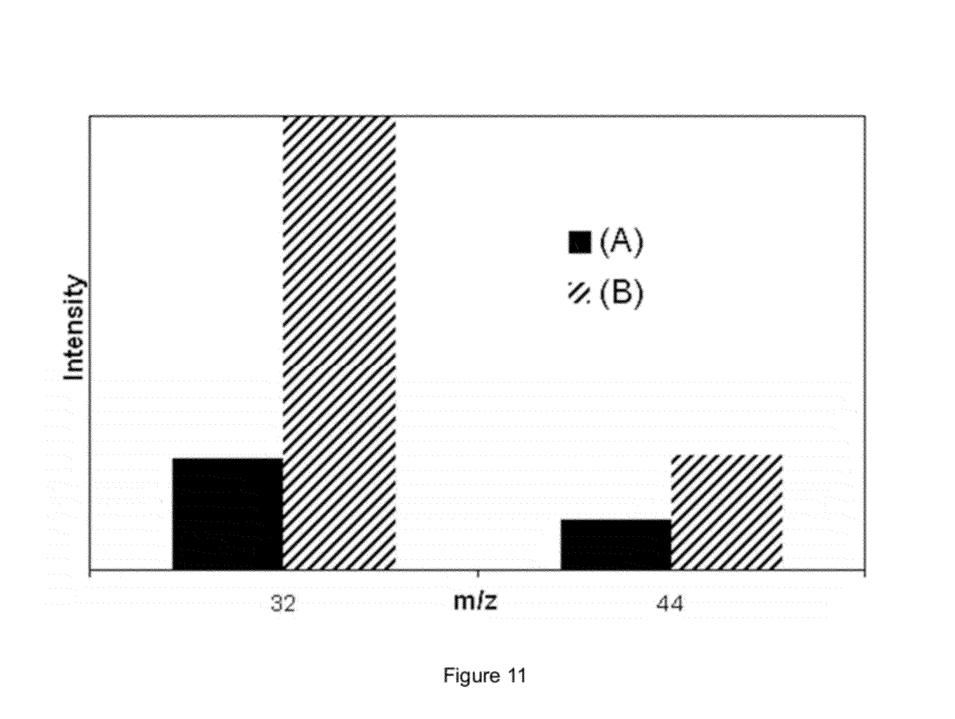

The anode effluent for cells maintained at −2V was analyzed using a mass spectrometer to identify the gaseous species present. With reference to FIG. 11, relevant results are shown for cathode streams containing O₂ with about 0% and about 10% CO₂. Peaks at approximately 32 and 44 represent the presence of O₂ and CO₂, respectively. Detection of these gases in the anode effluent indicates the electrolysis/oxidation of carbonate anions produced at the cathode back to O₂ and CO₂ (Equation 17). Still in reference to FIG. 11, increases of about 308% and 134% were observed for the O₂ and CO₂ concentrations, respectively, when the CO₂ content in the cathode stream was increased from 0% to 10%. The non-zero amount of CO₂ detected in the O₂-only experiments can be attributed to the leaching of CO₃⁻² from the carbonate-exchanged membrane, similar to CE Experiment 2, discussed above. Therefore, the considerable improvement in performance of the Ca₂Ru₂O_{7-y} cell after the introduction of CO₂ can be largely attributed to selective carbonate formation and increased operation on the carbonate cycle compared to the hydroxide cycle.

b. Room Temperature Carbonate Fuel Cell Performance

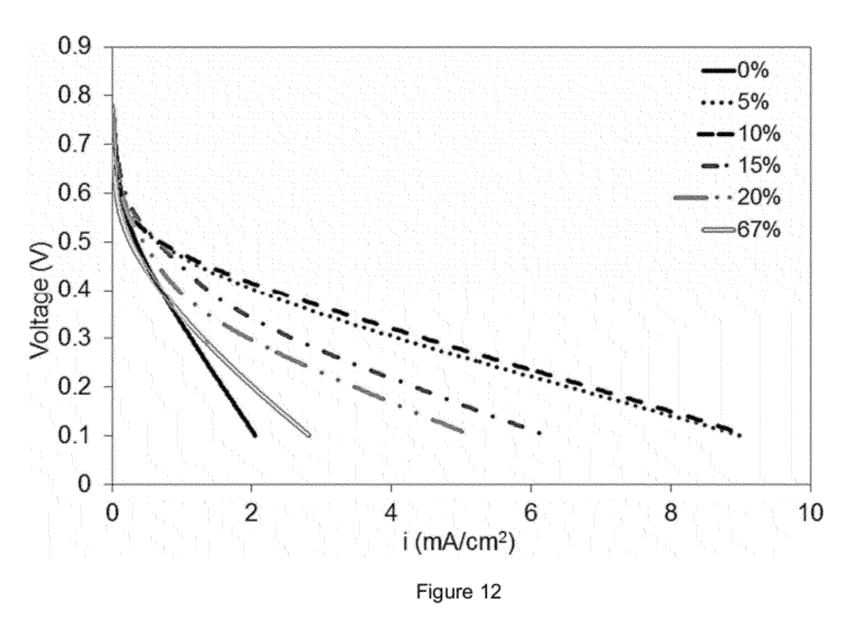

Different ratios of oxygen to carbon dioxide were used in the cathode stream to observe the effect of CO₂ concentration on RTCFC performance when Ca₂Ru₂O_{7-y} was used as a cathode catalyst. FIG. 12 shows linear sweep polarization curves for the RTCFC with different CO₂ concentrations in the cathode stream at 10 mV/s and 50° C. When no CO₂ was present in the cathode stream, poor performance was observed with a maximum current of 2 mA/cm². This poor performance could be due to reduced water adsorption on Ca₂Ru₂O_{7-y} and, thus, limited ORR activity by Equation 3. Additional increases in the CO₂ content of the cathode feed caused the performance of the cell to improve. A considerable increase in current was observed at low CO₂ concentrations and maximum performance was obtained with a CO₂ content of 10% in the cathode stream, where the current was enhanced over four times compared with the CO₂-free feed, which is shown in FIG. 12. Multiple runs showed the optimal CO₂ content on the cathode stream to be between approximately 10 to 12%. For a cell with a Pt/C cathode, increasing the CO₂ content of the cathode stream from 0% to 10% yielded a minimal increase in the current, suggesting operation on the hydroxide cycle and carbonate formation through the indirect route (see, e.g., Vega, J. A. et al., Electrochim. Acta, 55, 1638 (2010)).

Further additions of CO₂ above 10% caused the performance to gradually decrease, as can be seen in FIG. 12. However, even at approximately a 2:1 CO₂:O₂ ratio in the cathode stream, the performance was still slightly higher than with no CO₂. This diminished performance with higher CO₂ content in the cathode stream could be due to excessive adsorption of carbon dioxide during operation. As has been discussed, there exists a preferential adsorption of CO₂ over H₂O on Ca₂Ru₂O_{7-y}, which is evidenced by an approximately 400° C. difference in the desorption temperature of CO₂ (˜600° C.) and H₂O (˜200° C.). Ideally, the surface CO₂:O₂ molar ratio should be about 2:1, the stoichiometric amount required for the direct pathway carbonate ORR reaction (Equations 1 and 2). However, a catalyst with an overall high surface basicity and low to moderate electrochemical activity could lead to high CO₂ coverage and, consequently, O₂ site blocking. Oxygen desorption of adsorbed O₂ from a ruthenium surface has been observed to occur starting at approximately 400° C. (see, e.g., Bottcher, A. et al., Surf. Sci., 478, 229 (2001)). CO₂ desorption at a considerably higher temperature could imply a much lower CO₂ adsorption energy and, consequently, lead to diminished electrochemical activity and the mentioned O₂ site blocking phenomenon. Therefore, it is important to tailor the surface basicity of carbonate-selective catalysts for preferential adsorption of CO₂ over H₂O without introducing adsorptive competition between CO₂ and O₂ to yield a 2:1 CO₂:O₂ surface composition.

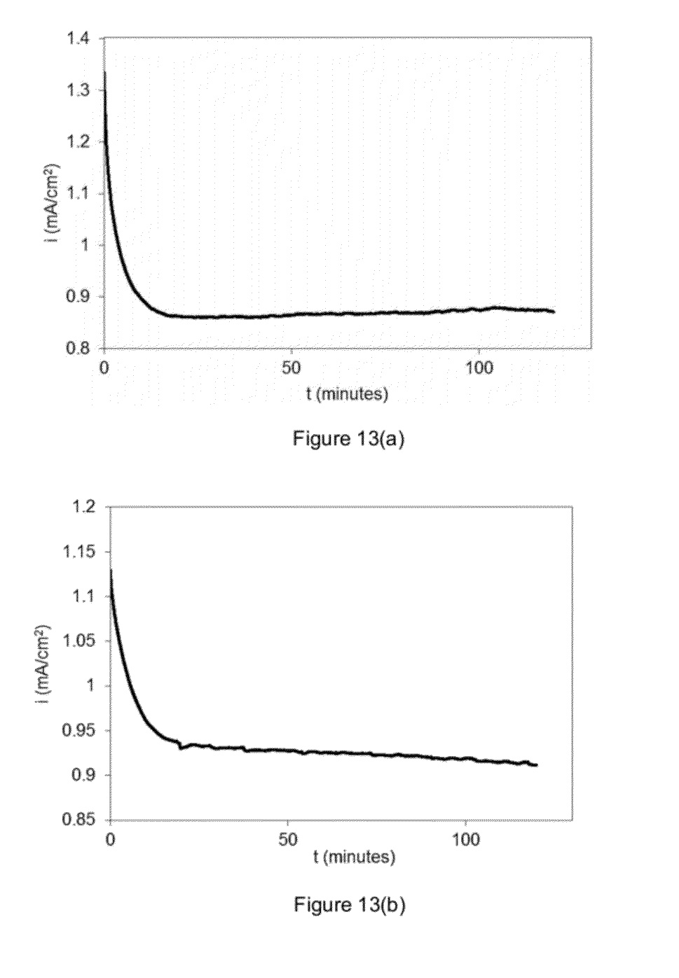

FIG. 13 shows chronoamperometric (CA) curves for the AEMFC using Ca₂Ru₂O_{7-y} as a cathode catalyst with different CO₂ content in the cathode stream operated at 0.25V. First, CA experiments were performed with a membrane exchanged to OH⁻ and 0% CO₂ on the cathode stream. A constant performance was obtained from this cell for the time period investigated, as is depicted in FIG. 13(a). In addition, the experiment was performed with a membrane exchanged to CO₃²⁻ and 5% CO₂. In this case, the performance of the cell slowly degraded over time. This result correlates with the behavior observed with linear sweep experiments with various CO₂ contents as shown in FIG. 13(b), where a decrease in performance was observed at high CO₂ concentrations. In this case, a slow gradual decrease is observed since the CO₂ content in the cathode stream is kept at a low concentration. It appears that the low CO₂ adsorption energy hinders the O₂ adsorption by disproportionately adsorbing CO₂ and blocking O₂ sites. This result stresses the importance of not only controlling the competitive adsorption between CO₂ and H₂O to obtain carbonate selectivity, but to also control the competitive adsorption of CO₂ and O₂ to optimize electrochemical activity and device performance.

c. Cyclic Voltammetry

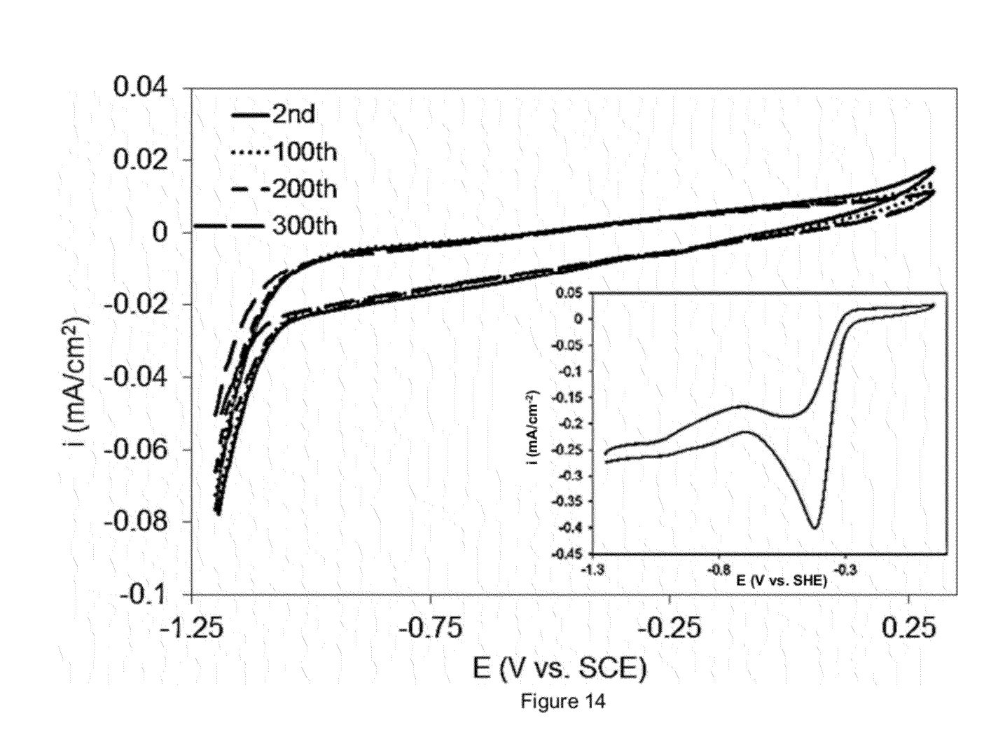

Ex-situ CV was used to investigate the electrochemical stability and activity of the Ca₂Ru₂O_{7-y} catalyst in the potential window relevant for the oxygen reduction reaction, −1.2 to 0.25V vs. SCE. With respect to FIG. 14, CVs for a thin-film Ca₂Ru₂O_{7-y} electrode in N₂-saturated 1M KOH at about 25° C. and 10 mV/s are shown. The catalyst showed some activity for hydrogen adsorption/desorption between about −1.2 and −1.0V vs. SCE. However, no redox peaks were observed between about −1.0 to 0.3V, where only capacitive behavior due to the electrochemical double layer was present, which indicated that the catalyst was redox stable in the region of interest. With further reference to FIG. 14, when the electrolyte was saturated with O₂, a clear oxygen reduction response appeared with a peak potential located at around −0.40V. As expected, the total current and the double layer region were shifted to more negative currents, which indicates that Ca₂Ru₂O_{7-y} is at least moderately oxygen active, analogous to the lead ruthenate pyrochlore (see, e.g., Prakash, J. et al., J. Electrochem. Soc., 146, 4145 (1999)).

The working electrode was cycled approximately 300 times between about −1.2 and 0.3V to determine the electrochemical stability of the catalyst. Minimal changes in the electrochemical response were observed from the second to the 300^{th} cycle. Also, the minimal change in current magnitude indicated negligible changes in physical or electrochemical aspects of the catalyst, i.e., surface roughening and electrochemically active area. These results suggest electrochemical stability of the catalyst over a wide potential window as well as chemical stability in alkaline media. A pressing limitation of state-of-the-art Pt catalysts is the loss of electrochemical activity during potential cycling due to Pt agglomeration or catalyst support corrosion (see, e.g., Shrestha, S. et al., Catal. Rev., In Press). However, the data depicted in FIG. 14 suggests that this is not an issue with the tested Ca₂Ru₂O_{7-y} pyrochlore.

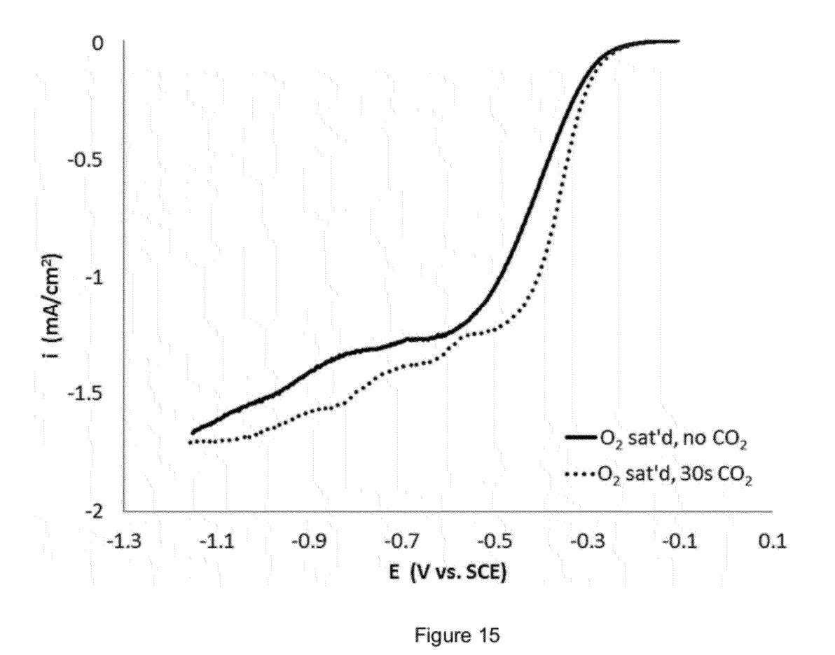

The activity of Ca₂Ru₂O_{7-y} for oxygen reduction through the hydroxide and carbonate pathways was investigated using the RDE technique. With respect to FIG. 15, cathodic voltammograms for the Ca₂Ru₂O_{7-y} electrode in O₂-saturated 1M KOH at about 25° C., 10 mV/s and 900 RPM are shown. In these experiments, voltammograms were obtained with and without CO₂ in the electrolyte. CO₂ was added to the electrolyte by bubbling for about 30 seconds only. Short bubbling times were used to prevent excessive acidification of the electrolyte, while still allowing for the CO₂ activity to be explored. The pH change due to the presence of CO₂ (approximately 0.1 pH units) was measured with a pH meter (Accumet Excel XL60) and the data in FIG. 15 was corrected for the potential shift due to the change in alkalinity (approximately −59 mV/pH).

Both lines have a similar shape with a sharp onset at −0.2 V vs. SCE followed by a gradual increase in negative current towards the mass transport limiting current. This shape was reproducible over many experiments and may be attributed to low activity intermediates and/or surface adsorption/blocking, leading to complex behavior. However, when CO₂ was added to the electrolyte, as represented by the dotted line in FIG. 15, the overpotential required for the ORR was reduced and higher currents were obtained over the entire potential range under investigation, compared to when no CO₂ was present, as represented by the solid line in FIG. 15. The result shown in FIG. 15 further suggest that CO₂ is electrochemically active on the catalyst and supports the selective carbonate formation observed during fuel cell operation. In addition, it appears that this catalyst has improved kinetics for the ORR with CO₂, rather than H₂O, presumably through the direct pathway.

The current response of a RDE is governed by the Koutecky-Levich equation, shown in Equation 18 below:

$$\frac{1}{i} = \frac{1}{{i}_{k}} + \frac{1}{{i}_{L}} \qquad ( 18 )$$

where i is the experimentally observed current, iₖ is the kinetic current and i_{L} is the mass transport limited current. In turn, the kinetic current is described by the Butler-Volmer equation, shown in Equation 19 below, and is a function of the electrode potential:

log(i)ₖ=log(iₒ)+bE (19)

where iₒ is the exchange current, E is the electrode potential and b is a constant dependent on temperature. Further, the kinetic current can be calculated from experimental RDE data using Equation 120 below:

$${i}_{k} = \frac{i * {i}_{d}}{{i}_{d} - i} \qquad ( 20 )$$

where i_{d} is the mass transport limited current. In Equation 20, it is assumed that ohmic losses are negligible in the solid and electrolyte phases.

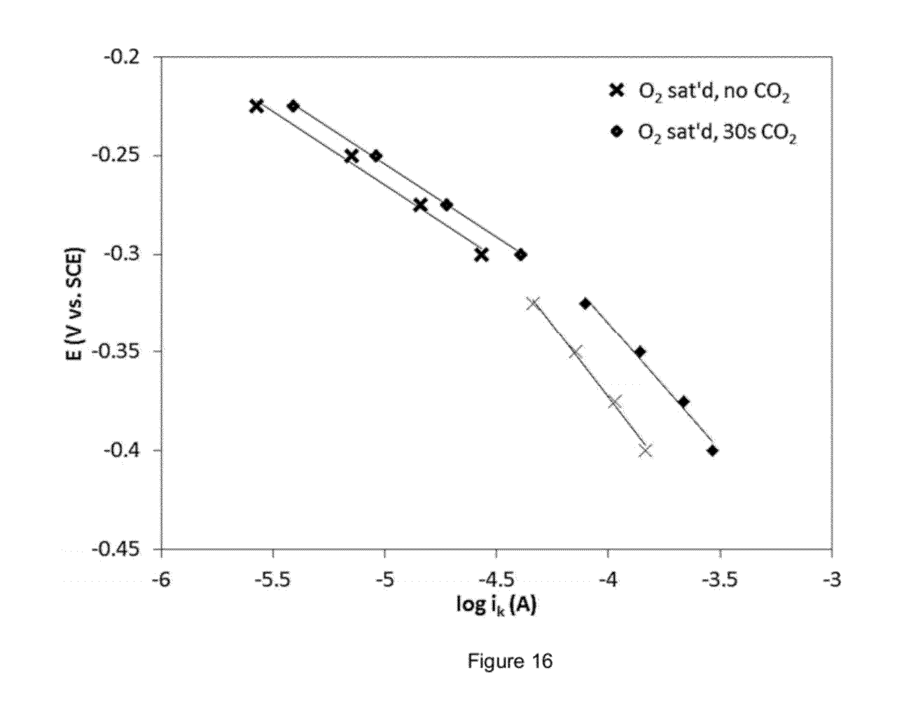

Turning now to FIG. 16, Tafel plots for the O₂-saturated 1M KOH electrolyte with and without CO₂ are depicted. The kinetic current was calculated using Equation 20 above, where the i_{d} used was the theoretical value for the 4 e⁻ ORR. The magnitude of iₖ was generally higher when CO₂ was present in the electrolyte, suggesting that carbonate formation is kinetically favored over hydroxide formation on Ca₂Ru₂O_{7-y}. With further reference to FIG. 16, there are two linear regions in each electrolyte in the low and high overpotential regions, respectively, a phenomenon also observed with Pt catalysts (see, e.g., Paulus, U. A. et al., J. Electroanal. Chem., 495, 134 (2001)). The Tafel slopes for both linear regions are listed in Table 3 below:

TABLE 3
Tafel slope for ORR in Ca₂Ru₂O_{7-y}

Tafel Slope
(mV/dec)

| Electrolyte | Dissolved Gas | Low η^{a} | High η^{a} |
|---|---|---|---|
| 1 | O₂ | 74 | 148 |
| 2 | O₂ + CO₂ | 74 | 129 |

^{a}η = overpotential

With reference to FIG. 16 and Table 3, in the low overpotential region, the Tafel slope was identical for both electrolytes (approximately 74 mV/dec). However, the curve for the carbonate ORR lies above the hydroxide ORR. Therefore, extrapolation of the Tafel line to the ORR formal potential would yield a higher iₒ under Equation 19 for the electrolyte containing CO₂, further suggesting the kinetically favored carbonate formation on Ca₂Ru₂O_{7-y}. In the high overpotential region, the Tafel slope for the O₂ electrolyte was about 148 mV/dec, while for the O₂+CO₂ electrolyte it was about 129 mV/dec, which may be attributed to either differences in the reaction mechanism, surface oxidation properties or reactant adsorption. Surface coverage of adsorbed species, which is dependent on the adsorption energy, has been shown to contribute to transitions or changes of the Tafel slope (see, e.g., Stamenkovic, V. et al., J. Phys. Chem. B, 106, 11970 (2002)).

Therefore, it appears that the carbonate ORR is favored compared the traditional hydroxide ORR on Ca₂Ru₂O_{7-y}. Consequently, this could create a localized low alkalinity environment within a fuel cell, extending the membrane life and maintaining stable long term performance (see, e.g., Vega, J. A. et al., J. Power Sources, 195, 7176 (2010)). This result, combined with the improved kinetics for hydrogen oxidation with carbonate anions compared to hydroxide anions (see, e.g., Vega, J. A. et al., J. Electrochem. Soc., 158, B349 (2011)), could lead to improved performance of an AEMFC operating on the carbonate cycle, instead of the hydroxide cycle.

d. X-ray Diffraction

The solid state reaction of base oxide precursors is the most common route for the synthesis of various pyrochlores (see, e.g., Ashcroft; A. T et al., J. Phys. Chem., 97, 3355 (1993); Beck, N. K. et al., Fuel Cells, 6, 26 (2006); Konishi, T. et al., Top. Catal., 52, 896 (2009); Sellami, M. et al., J. Alloy Compd., 493, 91 (2010); Uno, M. et al., J. Alloy Compd., 400, 270 (2005); Zhang, F. et al., Mater. Lett., 60, 2773 (2006); and Koteswara, K. et al., Spectrochim. Acta Part A, 66, 646 (2007)). Thus, Method 1, discussed above, initiated investigations on the synthesis of Ca₂Ru₂O_{7-y}.

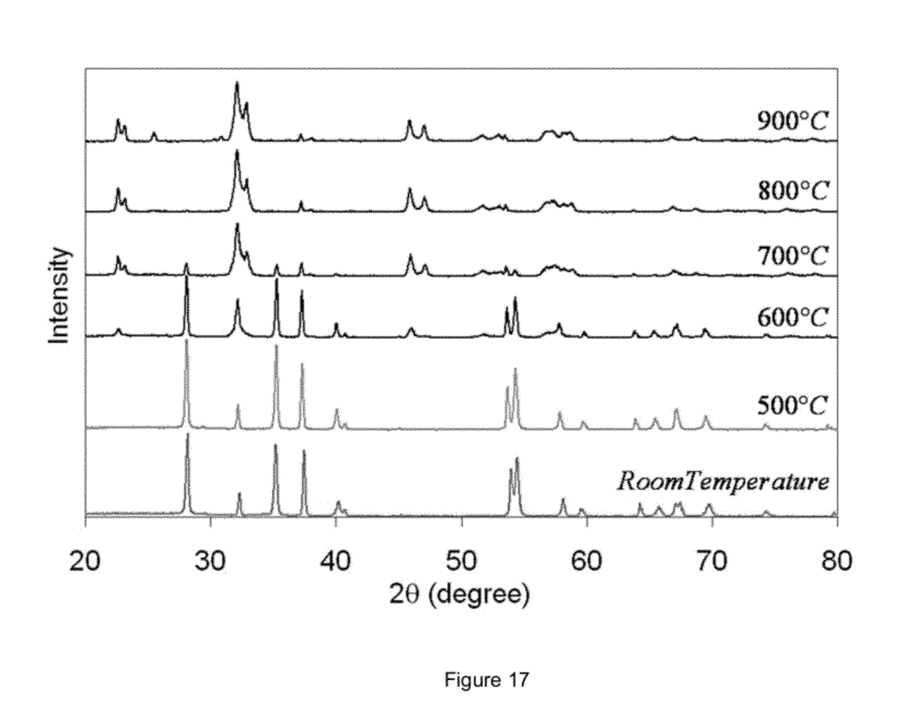

With reference to FIG. 17, the XRD pattern of CaO and RuO₂ mixtures that were heat treated at several temperatures up to approximately 900° C. is depicted. Reaction and crystal reorganization of the oxide precursors to higher order oxides was not feasible at moderate temperatures, which was observed in the identical XRD spectra at room temperature and about 500° C. Between approximately 600° C. and 900° C., the formation of a new crystal phase was observed with the appearance of peaks at about 22.8° and 41.2°. This was coupled with a reduction in CaO and RuO₂ peaks at about 37.4° and 28.1°, 35.1° and 40.0°, respectively. As the temperature was increased, the peak pattern became well-resolved, indicating further crystal rearrangement and growth during heat treatment. The XRD pattern at about 900° C. was consistent with that reported for perovskite structured calcium ruthenate, CaRuO₃ (see, e.g., Otonicar, M. et al., J. Am. Ceram. Soc., 93, 4168 (2010)).

With further reference to FIG. 17, the perovskite phase was further confirmed by XRD peak splitting at temperatures above approximately 600° C. This peak splitting phenomenon has been shown to be due to a phase change from a cubic to a tetragonal perovskite structure (see, e.g., Otonicar, M. et al., J. Am. Ceram. Soc., 93, 4168 (2010)). The single peaks observed at about 600° C. correspond to a cubic structure, while the dual peaks indicate a shift to a tetragonal symmetry at higher temperatures. Peak splitting was observed at around 22°, 32°, 46°, 52° and 58°, which correspond to (001)(100), (101)(110), (002)(200), (102)(201) and (112)(211) plane reflections, respectively. Unfortunately, even high temperature treatments, up to about 1100° C., were not sufficient to arrange the calcium ruthenate oxide to the pyrochlore structure. This has been previously observed during synthesis of calcium niobium pyrochlores, where high temperatures led to the formation of a perovskite-like structure (see, e.g., Aleshin, E. et al., J. Am. Ceram. Soc., 45, 18 (1962)). Without being bound by any theory, one possible explanation is the need for a stronger oxidizing atmosphere that will maintain the ruthenium cation in the +5 oxidation state required to form the pyrochlore. Also, solid state synthesis methods allow limited interaction between reactants, whose mass transport is limited by solid-state diffusion. This may allow the Ru⁺⁵ species to prematurely reduce to Ru⁺⁴ after thermal activation, facilitating the growth of the perovskite.

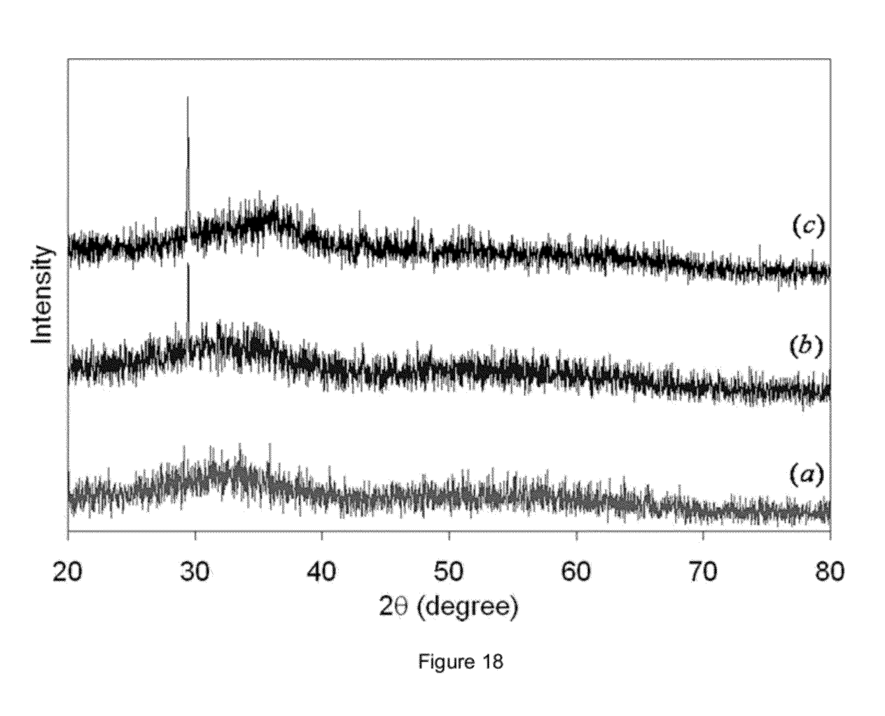

Turning now to FIG. 18, to address both limitations of the solid state reaction, an O₂-rich hydrothermal route, Method 2 discussed above, was attempted. FIG. 18 shows the XRD pattern for samples synthesized through Method 2 at approximately 75° C. and pH=14 for about (a)1, (b)2 and (c)3 days using a1:1 calcium to ruthenium molar ratio. With reference to curve (a) of FIG. 18, a reaction time of about one (1) day or less yielded a completely amorphous phase. The presence of an amorphous phase using this synthesis method has been previously observed in calcium niobium and calcium tantalum pyrochlores (see, e.g., Lewandowski, J. T. et al., Mat. Res. Bull., 27, 981 (1992)) and it has been suggested that this amorphous material is composed of mostly unreacted precursors (see, e.g., Aleshin, E. et al., J. Am. Ceram. Soc., 45, 18 (1962)). With further reference to curves (b) and (c) of FIG. 18, respectively, when the reaction was carried out for two (2) or three (3) days, the appearance of a peak at about 29.5° was observed. This peak, generally considered the major reflection of a pyrochlore phase, corresponds to the (222) plane. Reaction times of up to about five (5) days yielded the same result as curve (c) in FIG. 18. However, the material obtained is composed mostly of an amorphous phase, where the pyrochlore phase is not well defined. In a crystalline pyrochlore phase, other dominant refraction peaks are observed at about 50° and 60° 2θ, which correspond to the (440) and (622) crystal planes, respectively (see, e.g., Moller, T. et al., Micropor. Mesopor. Mat., 54, 187 (2002)). The absence of these peaks indicates a high degree of disorder for the material obtained through the O₂ hydrothermal route.

With further reference to FIG. 18, an array of synthesis conditions were studied in an effort to increase the crystallinity of the material. A decrease in temperature to about 55° C. did not allow a detectable reaction of the precursors. The material obtained had low crystallinity with very low intensity peaks that made the identification of a particular crystal difficult. An increase in temperature to about 95° C. also did not improve the crystallinity of the material obtained. Again, the only discernable peak in the XRD pattern was located at about 29.5°, similar to curve (c) in FIG. 18. Substantial evaporation of the reacting solution was observed at this temperature. Therefore, to prevent excessive evaporation of the reacting and precipitating medium, further temperature increases were not investigated.

It has been previously determined that changes in the A:B cation ratio may lead to different crystal phases depending on which element is in excess (see, e.g., Wu, X. et al., J. Mater. Sci. Lett., 16, 1530 (1997)). Several Ca:Ru molar ratios were investigated in this study, including the following: 2:1, 1.5:1, 1:1, 1:1.5 and 1:2. For reactions with an excess of calcium, unreacted calcium oxide was readily removed by washing with deionized water. Excess calcium did not have an effect on the product obtained, whose XRD pattern was analogous to curve (c) in FIG. 18. On the other hand, an excess of ruthenium at any level did not yield a product with a detectable crystal phase, but a completely amorphous material, whose XRD pattern was similar to curve (a) in FIG. 18. To remove any secondary phases, selective leaching was attempted by washing the precipitate with deionized water and glacial acetic acid. However, no crystal structure was detected after selective leaching. Therefore, a crystal phase within the amorphous material did not pass undetected during XRD analysis, but was simply not formed during reaction with a molar excess of ruthenium.

In addition, variation of the precursor bath pH had an effect at lower levels of alkalinity. At approximately pH=13, the product showed a crystalline XRD reflection at about 29.5°. However, the peak intensity was considerably decreased, by approximately 50%, compared to the precipitate obtained at about pH=14. This suggests a decrease in the extent of reaction, since a secondary phase present in small proportions may exhibit a lower intensity or even escape detection (see, e.g., Aleshin, E. et al., J. Am. Ceram. Soc., 45, 18 (1962)). A further decrease in pH to about 11 or 12 yielded a completely amorphous precipitate, again with an XRD pattern analogous to curve (a) in FIG. 18. Therefore, high alkalinity environments are generally necessary for the reaction and precipitation of a crystalline oxide.

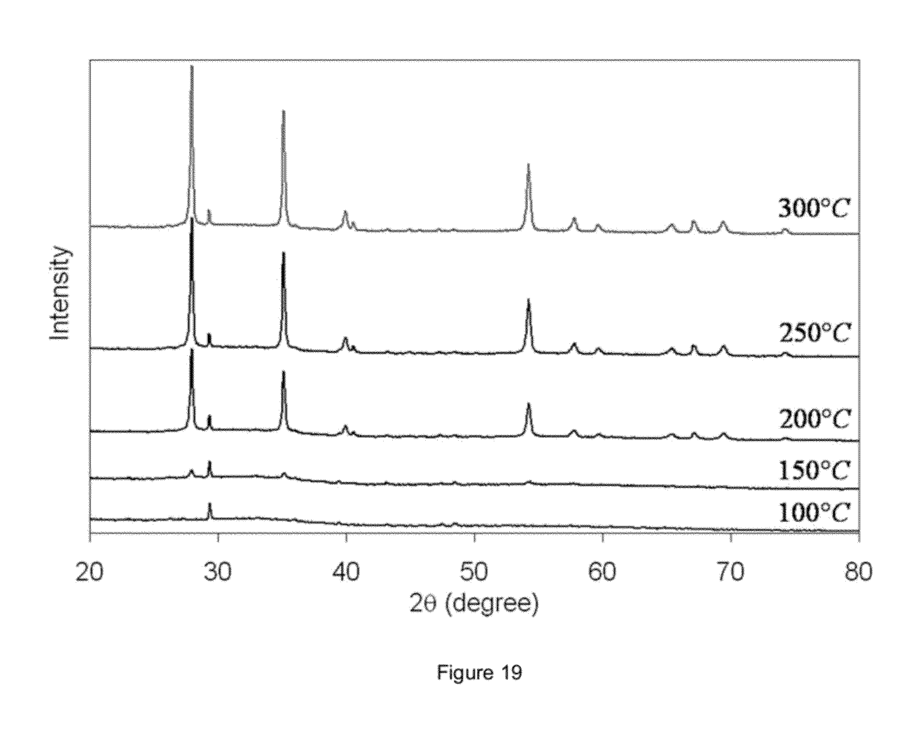

Now turning to FIG. 19, the in-situ XRD pattern for the precipitate obtained using Method 2, discussed above, at about 75° C., pH=14 and 1:1 Ca:Ru molar ratio for about three (3) days heated to different temperatures in air is shown. Heat treatment of some non- or low-crystalline precipitates has previously been shown to lead to the formation of higher crystallinity pyrochlores (see, e.g., Horowitz, H. S. et al., Mater. Res. Bull., 16, 489 (1981) and Bang, H. J. et al., Electrochem. Commun., 2, 653 (2000)). As can be seen in FIG. 19, the peak at about 29.4° was present at a temperature of approximately 300° C., suggesting that the crystal formed was thermally stable at this temperature. However, FIG. 19 further shows a slight phase transition starting at about 150° C., which became distinguishable at higher temperatures. The new peaks in the spectra corresponded mainly to RuO₂, which cannot be removed by washing the product with water since it is insoluble. Heating of the product in an oxygen-only atmosphere yielded an identical result. Heat treatment of completely amorphous precipitates also led to XRD patterns with defined peaks corresponding to RuO₂. Thus, an O₂-rich atmosphere maintains the Ru in the +4 oxidation state, but it is not strong enough to maintain a large amount of bulk Ru in the +5 oxidation state required for the formation of a highly crystalline calcium ruthenate pyrochlore. The amorphous phase was composed almost entirely of precursors from the reaction, and CaO was not detected since it is easily removed by washing the product with water.

The results depicted in FIG. 19 suggest that the formation of Ca₂Ru₂O_{7-y} requires: (i) a stronger oxidizing environment than O₂-saturated alkaline H₂O, and (ii) higher temperatures. Therefore, Method 3, discussed above, employed KMnO₄, a well-known strong oxidant. Also, use of KMnO₄, versus bubbling O₂, allowed the reaction vessel to be sealed and maintained at elevated synthesis temperatures under reflux.

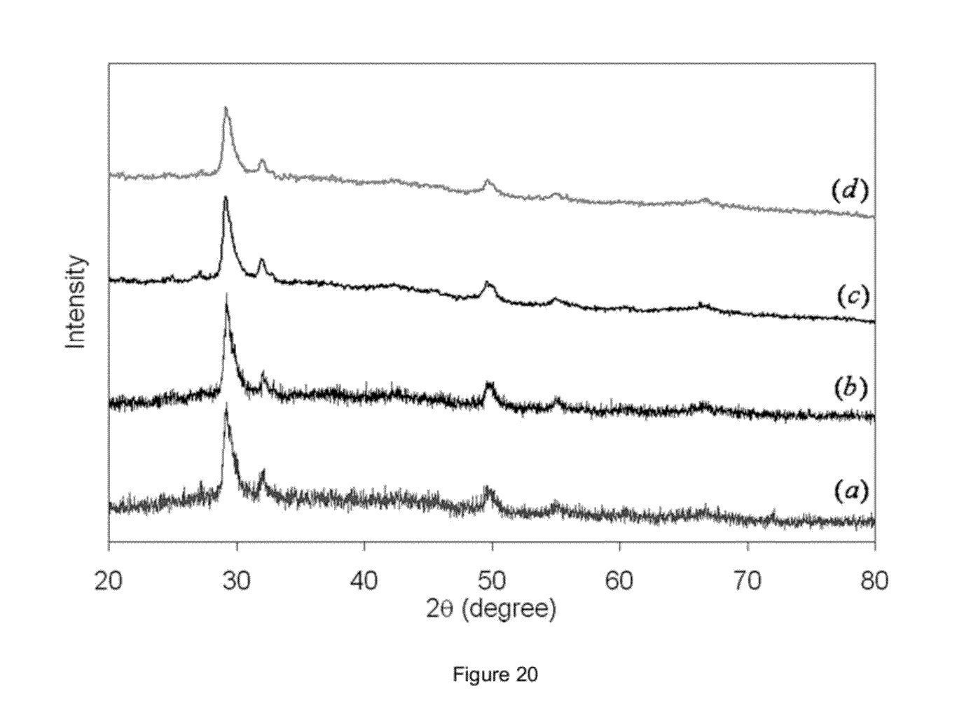

With reference to FIG. 20, the XRD pattern for samples synthesized by Method 3 at approximately 200° C., 1M KOH and 10 mM KMnO₄ for about (a) 0.5, (b)1, (c) 3 and (d) 5 days is shown. FIG. 20 illustrates well resolved XRD patterns with clear peaks at about 29.5° and 49.9°, corresponding to the (222) and (440) planes, respectively. The higher intensity of the peaks compared to FIG. 18 indicate a higher degree of crystallization when permanganate was used as the oxidant. Potassium permanganate most likely helps maintain the ruthenium cations in the +5 oxidation state required for the formation of a highly crystalline calcium ruthenate pyrochlore. The broad diffraction peaks indicate a small crystallite size. It is apparent that the use of a strong oxidizing agent played a crucial role in the formation of a highly crystalline calcium ruthenate pyrochlore. Curve (d) of FIG. 20 shows one added advantage of using permanganate was a considerable reduction in reaction time. Only about twelve (12) hours were required for the formation of the crystal, compared to a minimum of about two (2) days required for the formation of a mostly amorphous phase with Method 2, as shown in FIG. 18.

Still in reference to FIG. 20, temperature also played an important role in the degree of crystallization of the calcium ruthenate pyrochlore. A decrease of the reaction temperature to approximately 150° C. yielded a clear pyrochlore crystal with weaker XRD peak intensity compared to about 200° C. These results suggest a reduced reaction yield. A further decrease to around 100° C. yielded a material with a XRD pattern similar to curve (c) of FIG. 18. The precipitate obtained was an amorphous phase with one discernible reflection at a 20 of about 29.5°. Therefore, the potential of using higher temperatures with potassium permanganate likely assists the formation of Ca₂Ru₂O_{7-y}. However, higher temperatures were not investigated since KMnO₄ decomposes at approximately 240° C.

The oxidizing environment strength also affected the extent of reaction and the crystallinity of the precipitate. A decrease in the permanganate concentration to 1 mM during reaction yielded a precipitate with a low degree of crystallization. Therefore, it can be understood that both high temperature and a strong oxidizing environment are needed for the synthesis of crystalline Ca₂Ru₂O_{7-y}.

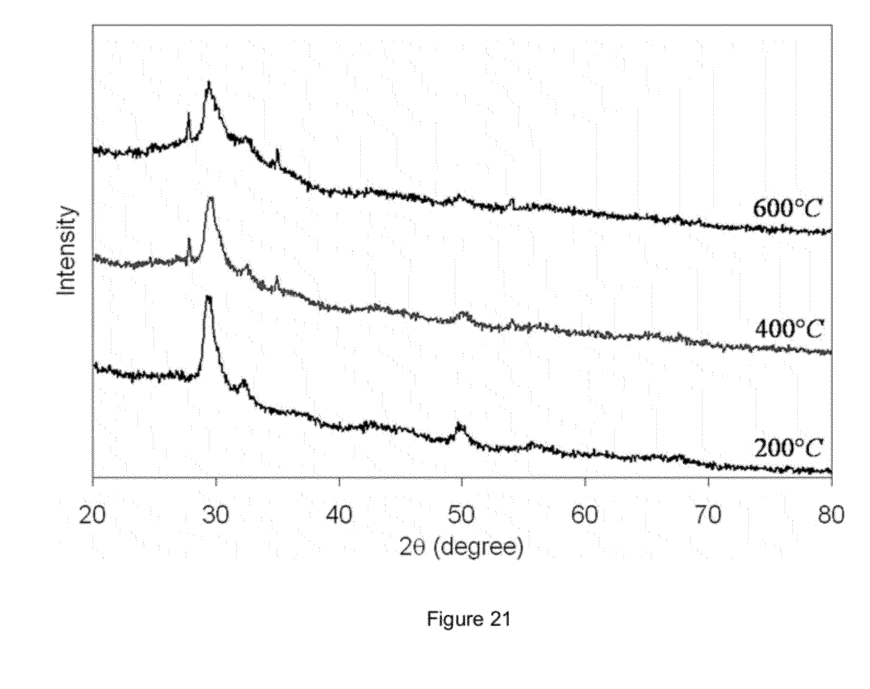

Turning now to FIG. 21, in-situ XRD patterns are shown for the product synthesized through Method 3 at about 200° C., pH=14, 10 mM KMnO₄ and 1:1 Ca:Ru molar ratio for about three (3) days heated to several temperatures up to approximately 600° C. At around 300° C., small diffraction peaks appear at 2θ of about 28.0° and 35.0°, which correspond to RuO₂. This suggests that although KMnO₄ yields mostly Ru⁺⁵, some Ru⁺⁴ was still obtained in its RuO₂ form. However, as can be seen in FIG. 21, the intensity of these reflections did not increase up to 600° C. and calcium oxide was again not detected. Therefore, the precipitate from the permanganate hydrothermal synthesis is highly crystalline and thermally stable. This demonstrates that the extent of reaction is much higher compared to the O₂ hydrothermal synthesis method, as depicted in FIG. 19, where a phase change to RuO₂ was observed. Moderate temperatures and a highly oxidizing atmosphere avoided the formation of an amorphous phase compromised of unreacted precursors and promote the formation of a highly crystalline Ca₂Ru₂O_{7-y} pyrochlore phase. In addition, the permanganate hydrothermal method presents a more accessible route for the synthesis of Ca₂Ru₂O_{7-y} compared to the previous method reported (see, e.g., Munenaka T. et al., J. Phys. Soc. Japan, 75, 103801 (2006)) where exotic conditions were required (approximately 600° C. and 150 MPa).

e. Microstructural Characterization

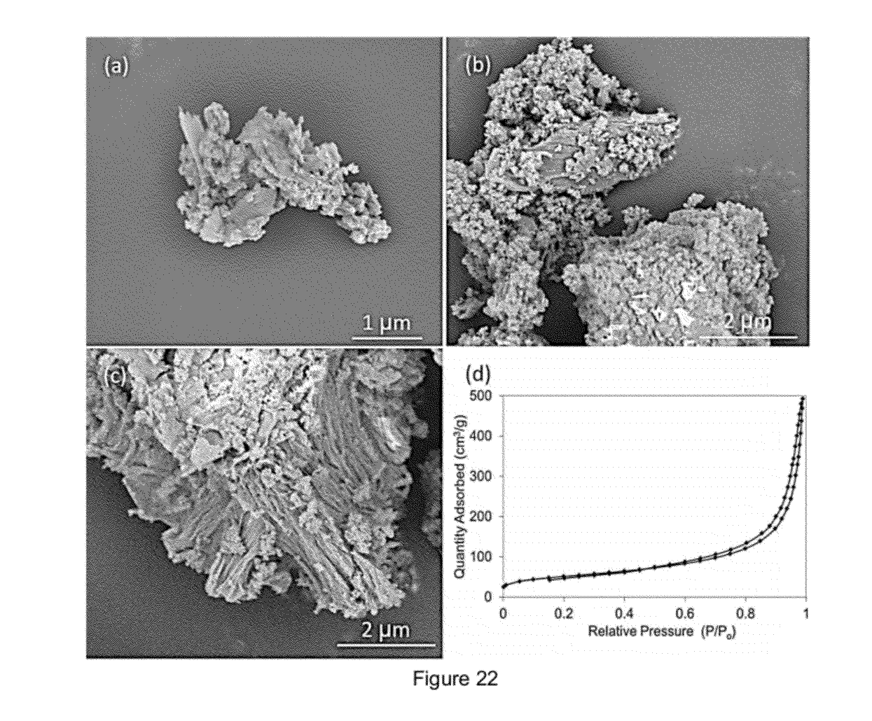

With respect to FIGS. 22(a)-(d), SEM images are shown of the pyrochlore synthesized through Method 3 at approximately 200° C., pH=14, 10 mM KMnO₄ for about three (3) days. FIG. 22(a) shows an isolated particle approximately 2 μm in size. This is a significant decrease in size compared to particles obtained by Munenaka and Sato (˜100 μm) (see, e.g., Munenaka, T. et al., J. Phys. Soc. Japan, 75, 103801 (2006)). In general, the particles obtained do not show an overall preferential geometric constitution, but are irregular in shape. Therefore, the hydrothermal synthesis did not induce specific geometries for the particles formed. FIG. 22(b) shows a birds-eye view SEM image of a small cluster of particles. The crystals contain flower-like extensions with a high surface roughness. In general, particles consist of the bulk material with a large number of nanocrystallites on the surface. These crystallites, with an average size of approximately 50 nm, give the Ca₂Ru₂O_{7-y} a high surface area. However, the lateral edges of the particles do not show crystallite growth, as can be seen in FIG. 22(c). This phenomenon suggests preferential crystal growth along specific planes during particle formation. It is likely that growth was along the (222) plane, which produced the distinctive diffraction peak at approximately 29.5° and may account for the missing (622) peak at about 60°.

Turning now to FIG. 22(d), the N₂ adsorption isotherm for the Ca₂Ru₂O_{7-y} synthesized through Method 3 was a Type II isotherm, which is typical of a non-porous or macroporous solid (see, e.g., Wu, X. et al., J. Mater. Sci. Lett., 16, 1530 (1997)). The hysteresis at higher relative pressures (>0.5 P/Pₒ) is characteristic of loosely assembled aggregates (see, e.g., Sing, K. S. W. et al., Pure Appl. Chem., 57, 603 (1985)). The isotherm has a “knee” around 0.05 P/Pₒ followed by a wide linear region up to 0.5 P/Pₒ and a convex curvature at even higher relative pressure. This type of isotherm denotes unhindered surface adsorption of N₂ molecules. The linear region of the isotherm begins at 0.05 P/Pₒ which was taken as “Point B” representing completion of monolayer coverage and the beginning of multilayer coverage (see, e.g., Sing, K. S. W. et al., Pure Appl. Chem., 57, 603 (1985) and Gregg, S. J. et al., Adsorption, Surface Area and Porosity, 2″ ed., Academic Press Inc, New York (1982)). A precise value of BET surface area is obtained when “Point B” is included in the range on which the BET equation is applied (see, e.g., Gregg, S. J. et al., Adsorption, Surface Area and Porosity, 2^{nd} ed., Academic Press Inc, New York (1982)). Hence, the BET surface area was calculated between 0.002 and 0.1 P/Po. Equation 21 shows the BET equation (see, e.g., Brunauer, S. et al., J. Am. Chem. Soc., 60, 309 (1983)),

$$\frac{1}{υ ( {P}_{o} / P - 1 )} = \frac{1}{{υ}_{m} c} + \frac{c - 1}{{υ}_{m} c} \frac{P}{{P}_{o}} \qquad ( 21 )$$

where c is the BET constant that provides a measure of adsorbent-adsorbate interaction energy, P is the equilibrium pressure, Pₒ is the saturation pressure at the temperature of adsorption, ν is the adsorbed gas quantity, and νₘ is the volume of an adsorbed N₂ monolayer. Using Equation 21, the monolayer capacity (νₘ) was calculated to be around 40 cm³/g, which was very close to the volume adsorbed at 0.05 P/Pₒ (39 cm³/g) validating our choice of 0.05 P/Pₒ as the “Point B”. Thus, the calculated BET surface area of the Ca₂Ru₂O_{7-y} pyrochlore was approximately 174 m²/g, a high surface area considering that it is unsupported, making it feasible for catalytic applications. It is also at least one order of magnitude higher compared to other pyrochlores found in the literature used for electrochemical applications (see, e.g., Konishi, T. et al., Top. Catal., 52, 896 (2009); Bang, H. J. et al., Electrochem. Commun., 2, 653 (2000); and Kahoul, A. et al., J. Solid State Chem., 161, 379 (2001)). The external surface area, determined from the linear region of t-plot using Harkins and Jura parameters (see, e.g., Harkins, W. D. et al., J. Am. Chem. Soc., 66, 1366 (1944)) was approximately 162 m²/g. This suggests a limited contribution of micropore area (12 m²/g) to the total surface area. However, Harkins and Jura derived their parameters on TiO₂, and a standard more similar in surface properties to the synthesized Ca₂Ru₂O_{7-y} may yield a more definitive determination of the relative micropore and the external surface areas.

f. Temperature Programmed Desorption

An essential characteristic of a carbonate selective electrocatalyst must be the preferential adsorption of carbon dioxide over water. TPD is a common method to identify molecules physically and chemically adsorbed on the surface of a catalyst and determine their adsorption energies (see, e.g., Punyawudho, K. et al., Langmuir, 27, 3138 (2011) and Punyawudho, K. et al., Langmuir, 27, 7524 (2011)). In general, molecules that desorb at a higher temperature have a higher desorption activation energy (Eₐ) or a lower adsorption Eₐ. Here, TPD was performed after exposure of Pt/C or Ca₂Ru₂O_{7-y} to water or carbon dioxide.

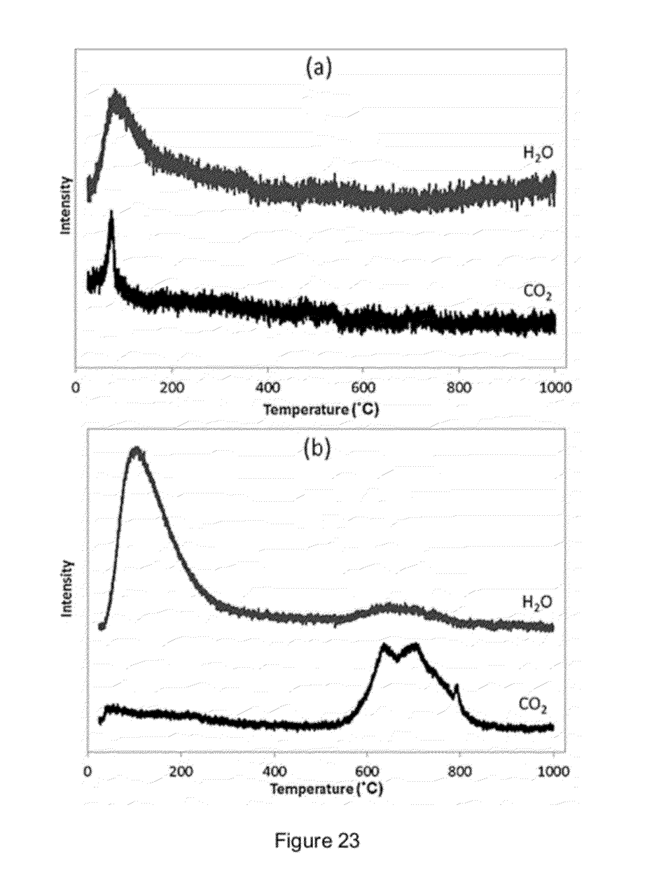

With reference to FIG. 23(a), the TPD of Pt/C is shown after exposure to humidified He or CO₂. It is well known that carbon contains oxygen functional groups that are formed by exposure to the atmosphere, as well as oxidative and thermal treatments (see, e.g., Figueiredo, J. L et al., Carbon, 37, 1379 (1999)). Carbonyl, carboxyl, ether, phenol, quinone and lactone groups have all been identified on carbon surfaces (see, e.g., Figueiredo, J. L et al., Carbon, 37, 1379 (1999)). These surface oxygen groups decompose and release CO and CO₂ during heating. Assignment of specific surface groups using TPD peaks remains a challenge as the peak position and resolution is dependent on the heating rate, the surface geometry of the material and the arrangement of the equipment used (see, e.g., Falconer, J. L. et al., Catal. Rev. Sci. Eng., 25, 141 (1983) and Boehm, H. P., Carbon, 32, 759 (1994)). Therefore, to eliminate the contribution of these surface oxide groups, background TPD was obtained under dry He flow and subtracted from the CO₂ experiments, yielding data consisting only of adsorbed molecular CO₂.

FIG. 23(a) further shows a clear peak for both adsorbed H₂O and CO₂ on Pt/C. The H₂O peak was observed at around 80° C., while the CO₂ peak materialized at approximately 71° C. In addition, the H₂O peak was broader than the CO₂ peak, which indicates a higher quantity of adsorbed water of this catalyst compared to CO₂. Thus, Pt catalysts preferentially adsorb water over carbon dioxide. In turn, this suggests that during fuel cell operation, Pt/C would favor Equation (3) over Equation. (5) and an AEMFC would operate primarily on the hydroxide cycle, rather than the carbonate cycle. This phenomenon has been observed in AMEFCs operating with Pt/C as the cathode catalyst and O₂/CO₂ mixtures in the cathode stream (see, e.g., Vega, J. A. et al., Electrochimica Acta, 55, 1638 (2010) and Unlu, M. et al., Electrochem. Solid State, 12, B27 (2009)) and has been discussed in detail above.

Turning now to FIG. 23(b), TPD results are shown for Ca₂Ru₂O_{7-y} synthesized through Method 3 at approximately 200° C. in 1M KOH and 10 mM KMnO₄ after exposure to humidified He or CO₂. There is a clear H₂O peak at around 94° C. after exposure to water, showing that this catalyst is able to adsorb water when exposed to humidified environments. This may be an early indication that this catalyst can potentially work as an oxygen reduction catalyst, analogous to the lead ruthenate pyrochlore (see, e.g., Prakash, J. et al., J. Electrochem. Soc., 146, 4145 (1999)). After exposure to CO₂, desorption was observed at considerably higher temperatures (>600° C.) compared to water. This elevated desorption temperature may suggest a low adsorption Eₐ for CO₂ and its preferential adsorption over H₂O.

The reason for this preferential adsorption of CO₂ in Ca₂Ru₂O_{7-y} may be the presence of calcium, an earth alkaline metal, which gives this pyrochlore a high surface basicity. Since CO₂ is a stronger Lewis acid, compared to H₂O, this molecule is preferentially adsorbed due to acid-base interactions. This makes Ca₂Ru₂O_{7-y} a promising initial candidate for a carbonate selective catalyst.

g. Low Temperature Methane Conversion Device or CO₂ Conversion Device

By way of background, room temperature electrochemical reactors operating on the carbonate anion cycle utilizing polymer electrolyte membranes have been proposed as a response to the low chemical stability of commercial anion exchange membranes in the presence of OH-(see, e.g., Lang, C. M. et al., High-Energy Density, Room-Temperature Carbonate Fuel Cell, Electrochemical and Solid State Letters, 9, A545-A548 (2006) and Varcoe, J. R. et al., Prospects for Alkaline Anion-Exchange Membranes in Low Temperature Fuel Cells, Fuel Cells, 5, 187-200 (2005)). Since then, additional work has confirmed that carbonate-exchange membranes have high ion exchange capacity and are generally stable (see, e.g., Vega, J. A. et al., Effect of hydroxide and carbonate alkaline media on anion exchange membranes, Journal of Power Sources, 195, 7176-7180 (2010); Adams, L. A. et al., A Carbon Dioxide Tolerant Aqueous-Electrolyte-Free Anion-Exchange Membrane Alkaline Fuel Cell, ChemSusChem, 1, 79-81 (2008); Zhou, J. et al., Anionic polysulfone ionomers and membranes containing fluorenyl groups for anionic fuel cells, Journal of Power Sources, 190, 285-292 (2009); and Tones, C. I. et al., Carbonate Species as OH⁻ Carriers for Decreasing the pH Gradient Between Cathode and Anode in Biological Fuel Cells, Environmental Science and Technology, 42, 8773-8777 (2008)). However, practical operation of room temperature carbonate devices requires the selective formation of carbonate (Equation 9) over OH⁻ (Equation 22) at the cathode under fully humidified conditions.

½O₂+H₂O+2e⁻→OH⁻ (22)

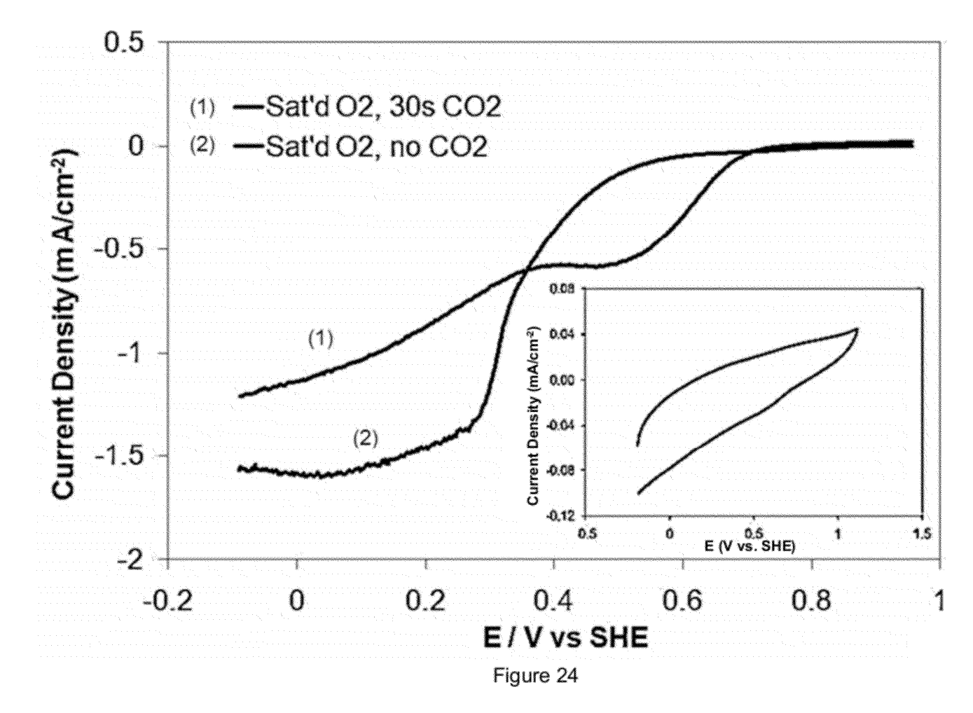

An advantageous finding of the disclosed exemplary electrochemical reactors, as discussed above, is the design and discovery of the first and only catalyst—Ca₂Ru₂O₇—that is shown to selectively form carbonate electrochemically at or about room temperature under fully humidified conditions (see, e.g., Vega, J. A. et al., Carbonate Selective Ca₂Ru₂O_{7-y} Pyrochlore Enabling Room Temperature Carbonate Fuel Cells—Part I. Synthesis and Physical Characterization, J. Electrochem. Soc., In Press, DOI: 10.1149/2.028201jes; and Vega, J. A. et al., Carbonate Selective Ca₂Ru₂O_{7-y} Pyrochlore Enabling Room Temperature Carbonate Fuel Cells—Part II. Verification of Carbonate Cycle and Electrochemical Performance, J. Electrochem. Soc., In Press, DOI: 10.1149/2.029201jes). Ca₂Ru₂O₇ possesses a carbonate selectivity, shown by Equation 23 below, of approximately 7.33, suggesting that about 88% of the reacted O₂ is converted to CO₃⁻². This compares favorably to Pt, whose selectivity in other preliminary experiments has been estimated to be less than about 0.5. The enhanced activity for Equation 9 over Equation 22 is also shown in FIG. 24. In particular, FIG. 24 illustrates the linear sweep voltammograms for Ca₂Ru₂O₇ in O₂ and O₂/CO₂ electrolytes. As can be seen from FIG. 24, in the presence of CO₂, the oxygen reduction potential in alkaline media is pushed to more positive potentials.

$$( S = \frac{rate\_rxn 1}{rate\_rxn 4} ) \qquad ( 23 )$$

Another advantageous finding is that the hydrogen oxidation reaction is kinetically favored in carbonate media compared with hydroxide (see, e.g., Vega, J. A. et al., Hydrogen and Methanol Oxidation Reaction in Hydroxide and Carbonate Alkaline Media, Journal of the Electrochemical Society, 158, B349-B354 (2011)). It has been found that oxidation reactions with carbonate anions have low free energy intermediates generally due to the thermodynamic favorability of CO₂ formation from CO₃⁻² on Pt. This is a positive result, indicating that CO₃⁻² may generally be an efficient oxygen donating species for electrochemically activating methane, as illustrated in Equation 10.

A further advantageous finding is that polymer membranes exchanged to the carbonate form are extremely durable. Five commercially available membranes were investigated and showed no measurable reduction in ionic conductivity or chemical degradation over a 30 day period. Generally, this is in contrast to hydroxide exchanged membranes, whose mechanical integrity was compromised and conductivity decreased by an approximate range of 6-27% over the same span (see, e.g., Vega, J. A. et al., Effect of hydroxide and carbonate alkaline media on anion exchange membranes, Journal of Power Sources, 195, 7176-7180 (2010)). The conductivity of CO₃⁻² through the polymer membranes is approximately 50% of that of OH⁻. However, it can typically be raised by preparing lower molecular weight polymer electrolytes that possess higher ion exchange capacity and allow enhanced mobility of the anion.

An alternative advantageous finding is that carbonate anions can be used at the anode as a high efficiency oxygen donator to oxidize incoming feeds other than hydrogen. Most notably, the preliminary data shows that a coprecipitated NiO/ZrO₂ composite catalyst facilitates Equation 10, thereby electrochemically oxidizing methane to syngas at approximately 40° C. This coprecipitated catalyst is designed to satisfy several criteria (see, e.g., Spinner, N. et al., Effect of Nickel Oxide Synthesis Conditions On Its Physical properties and Electrocatalytic Oxidation of Methanol, Electrochimica Acta, 56, 5656 (2011)). One criteria is that the coprecipitated catalyst should have electrocatalytically active sites, thereby being electrically conductive. Another criteria is that the coprecipitated catalyst should have the ability to adsorb carbonate and transport it to the active sites. In exemplary embodiments of the present disclosure, NiO and ZrO₂ were selected as candidates to fill these needs, respectively.

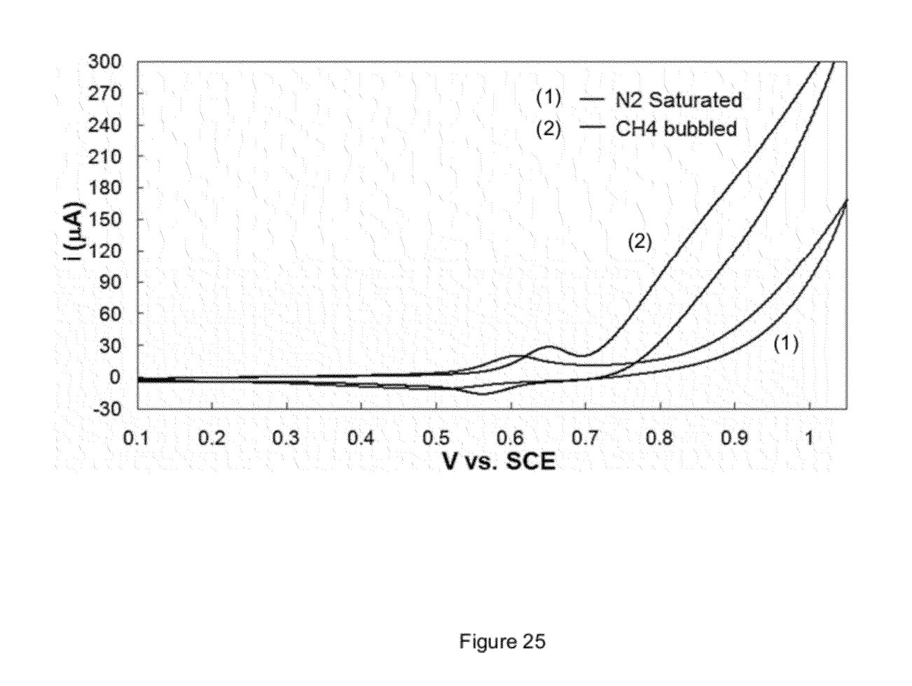

With reference to FIG. 25, a cyclic voltammogram is depicted for the NiO—ZrO₂ catalyst in about 0.1 M Na₂CO₃ solution bubbled with inert N₂ and saturated with CH₄. Under inert conditions, the typical Ni⁺²/Ni⁺³ redox couple may be observed (see, e.g., Periana, R. A. et al., Platinum Catalysts for the High-Yield Oxidation of Methane to a Methanol Derivative, Science, 280, 560-564 (1998)). Under CH₄-saturation, peak separation, coupled with a distinct increase in the anodic current around 0.75 V vs. SCE, was observed, indicating an additional oxidation reaction.

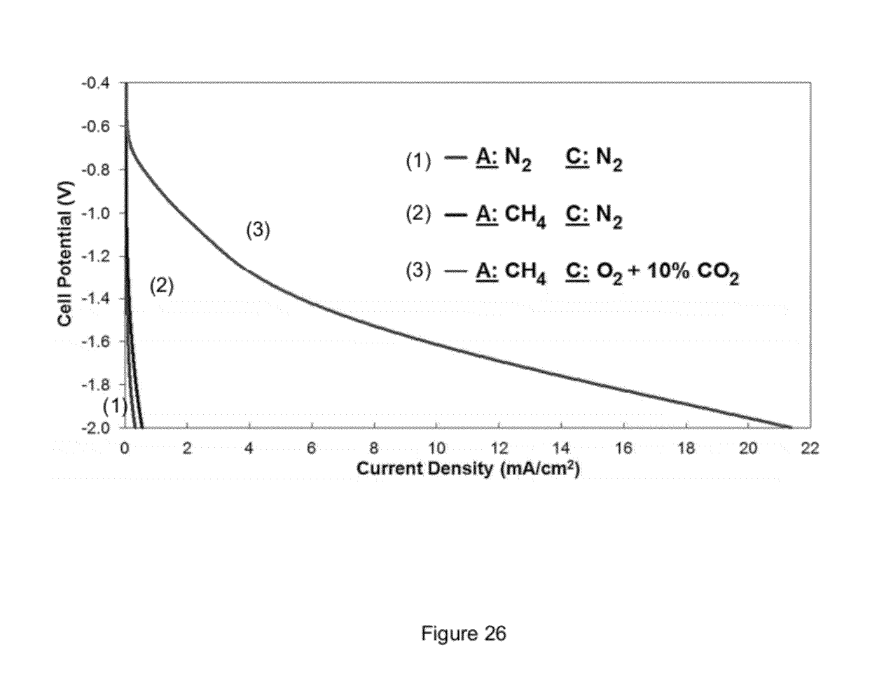

In order to identify the product formed from this new oxidation reaction, room temperature electrochemical reactors (e.g., devices 100′ of FIGS. 4(a) and 4(b)) were assembled with Ca₂Ru₂O₇ (130′) and NiO—ZrO₂ (150′) at the cathode 102′ and the anode 103′ respectively. With reference to FIG. 26, performance curves for the control and conversion experiments are shown. As can be seen from FIG. 26, there is an increase in the observed current when humidified O₂ and CO₂ are fed to the cathode 102′ and humidified CH₄ is fed to the anode 103′. Further, the observed current density, approximately 21 mA/cm², obtained at about 2V applied, is more advantageous to previously reported electrochemical reactors reported in prior art literature for CO production from CO₂ electrolysis, which normally require greater than about 4V to achieve the disclosed current density (see, e.g., Periana, R. A. et al., Catalytic, Oxidative Condensation of CH₄ to CH₃COOH in One Step via CH Activation, Science, 301, 814-818 (2003) and An, W. et al., The Electrochemical Hydrogenation of Edible Oils in a Solid Polymer Electrolyte Reactor. I. Reactor Design and Operation, Journal of the American Oil Chemists' Society, 75, 917-925 (1998)).

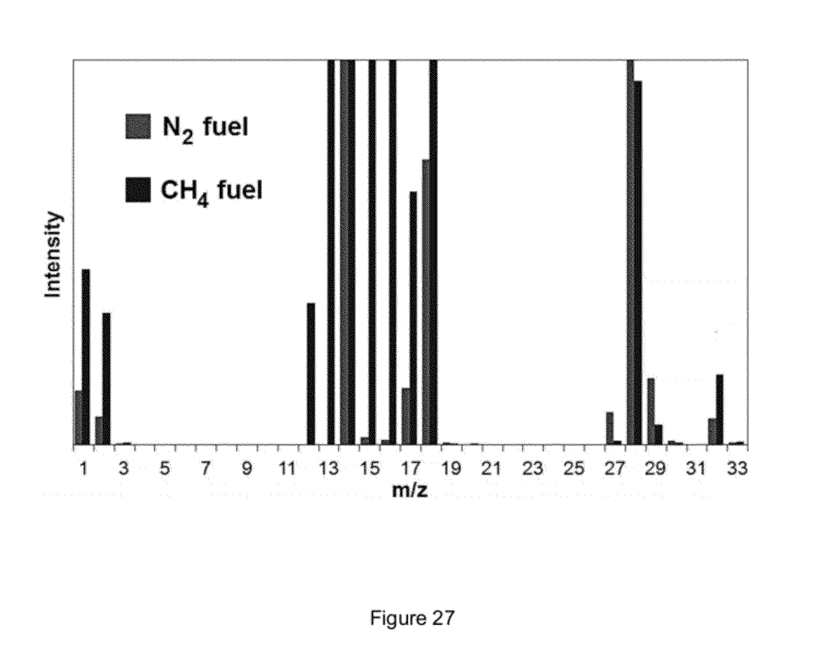

The anode effluent gas was analyzed using mass spectrometry. Turning now to FIG. 27, the mass spectrum for CH₄ fuel is depicted as the darker shade. FIG. 27 further illustrates peaks at m/z values of approximately 2, 28, and 32, which, when compared to data with N₂ at the anode, depicted as the lighter shade, indicate the presence of H₂, CO, and O₂, respectively. The presence of CO was also confirmed by gas chromatography (GC).

However, the exemplary embodiments of the CO₂ conversion device 100′ are not limited to the disclosed anode 103′ electrode materials. In particular, electrocatalysts 150′ for the oxidation of methane to syngas generally are required to meet several criteria. First, the catalyst 150′ generally should have a methane active center, i.e., so that CH₄ is both adsorbed and electrochemically activated on the surface. In addition, as CO₃⁻² is the charge-carrying/transfer species in the system, it typically needs to be adsorbed and have improved surface mobility. Surfaces with a slightly alkaline character generally facilitate carbonate adsorption through Lewis acid/base interactions while the high surface mobility will allow adsorbed CO₃⁻² and CH₄ to intimately interact. Further, the molecular, not dissociative, adsorption of C—O containing species typically should be thermodynamically favored. This will not only ensure that methane will accept an oxygen atom from carbonate, it also generally ensures that the resulting carbon monoxide will not be further oxidized at low overpotentials, thereby providing a large operating window for the reactor.

Three exemplary catalyst materials that have demonstrated reactivity with methane, although at elevated temperatures, have improved electronic conductivity at or about room temperature, i.e., ideal for electrochemical applications, and the ability to adsorb short chain organics while having poor C—O bond cleavage activity are as follows: (i) NiO, which has been utilized to collect successful preliminary data; (ii) CoO; and (iii) MnO (see, e.g., Zafeirator, S. et al., Methanol oxidation over model cobalt catalysts: Influence of the cobalt oxidation state on the reactivity, Journal of Catalysis, 269, 309-317 (2010); Zhang, X. et al., Catalytic conversion of methane to methanol over Lanthanum-Cobalt-Oxide supported Molybdenum based catalysts, Prepr. Pap. Am. Chem. Soc., Div. Fuel Chem., 48, 837-838 (2003); Mann, R. S. et al., Oxidation of Methanol Over Manganese Dioxide-Molybdenum Trioxide Catalyst, Industrial and Engineering Chemistry Process Design and Development, 9, 43-46 (1970); and Samant, P. V. et al., Nickel-modified manganese oxide as an active electrocatalyst for oxidation of methanol in fuel cells, Journal of Power Sources, 79, 114-118 (1999)). On all three catalysts, the surface molecular adsorption of CO is preferred in their neat form with an M⁺² (e.g., a transition metal “M”, such as, for example, M=Ni, Co, Mn) oxidation state. However, on all three catalysts, a transition to M⁺³ is typically required for the oxidation reaction. This reversible transition was observed for NiO, as illustrated in FIG. 25, at around 0.55 V vs. SCE, which provides a large operating window for methane conversion while not allowing for CO oxidation until high overpotentials.

On the other hand, these materials have generally not shown sufficient surface alkalinity to adsorb carbonate anions. One catalyst that has proven carbonate activity is ZrO₂ and it is hypothesized that ZrO₂ is able to facilitate the methane conversion reaction in preliminary data by providing a CO₃⁻² adsorption center, while NiO provides the methane active site (see, e.g., Jung, K. T. et al., An in Situ Infrared Study of Dimethyl Carbonate Synthesis From Carbon Dioxide and Methanol Over Zirconia, Journal of Catalysis, 204, 339-347 (2001)). This may suggest that all three transition metal oxide:ZrO₂ electrocatalysts (e.g., MO:ZrO₂) are generally active in converting methane to syngas. However, ZrO₂ typically has a low electronic conductivity and large quantities may not be incorporated into the catalyst. Thus, to maximize the contact interface between the transition metal oxide (e.g., MO) and ZrO₂, thereby increasing catalyst utilization and allowing for minimal inclusion of the non-conductive ZrO₂, a coprecipitation route that was developed to synthesize NiO:ZrO₂ composites may also be used to synthesize CoO:ZrO₂ and MnO:ZrO₂ (see, e.g., Spinner, N. S. et al., Effect of Nickel Oxide Synthesis Conditions On Its Physical Properties and Electrocatalytic Oxidation of Methanol, Electrochimica Acta, submitted (2011)).

6. Experimental Results Summary

As discussed in greater detail above, synthesis of Ca₂Ru₂O₇ was investigated using both solid-state and hydrothermal methods. Heating of precursor oxide salts, CaO and RuO₂, at temperatures up to approximately 1100° C. led to the formation of a perovskite phase. A low temperature O₂ hydrothermal route led to the formation of a low crystallinity pyrochlore phase though the bulk of the precipitate was an amorphous material which consists mainly of RuO₂. A third synthesis method was employed, using KMnO₄ as an oxidizing agent. The permanganate hydrothermal synthesis led to the formation of a highly crystalline calcium ruthenate pyrochlore.

Using XRD, it was shown that the pyrochlore was thermally stable and the reaction had a high yield. Therefore, Ca₂Ru₂O_{7-y} was successfully synthesized at moderate temperatures and low pressures. The material had a unique morphology and small particle size compared to other pyrochlores. Further, high surface area was obtained, likely due to the small particle size and the formation of nanocrystallites on the surface of the particles. TPD also showed the preferential adsorption of H₂O versus CO₂ in a Pt/C catalyst. However, CO₂ was preferentially adsorbed in the Ca₂Ru₂O_{7-y} pyrochlore, compared to H₂O, making it a feasible candidate for a carbonate selective catalyst.

The experimentations discussed above show that pyrochlores can be obtained through low temperature, low pressure synthesis routes. The use of a strong oxidizing agent created the environment required to control and maintain the high ruthenium oxidations states necessary for the formation of the crystal. This creates a valuable synthesis method, allowing for high surface area materials with unique properties that would be beneficial for the use of high surface area pyrochlores as heterogeneous catalysts. The introduction of an alkaline earth metal in the structure allowed the tailoring and increase of the surface basicity. This characteristic led to the preferential adsorption of CO₂ over H₂O, an essential requirement for a carbonate selective catalyst.

Further, the experimentations discussed above explored the electrochemical activity of a Ca₂Ru₂O_{7-y} pyrochlore and its selectivity towards carbonate formation. The presence of carbon dioxide at the anode was demonstrated by precipitation of CaCO₃ from a Ca(OH)₂ solution. The selectivity of Ca₂Ru₂O_{7-y}), for carbonate formation was demonstrated to be considerably higher than Pt/C. Also, mass spectra of the anode effluent showed a considerable increase in the CO₂ quantity when CO₂ was present at the cathode, suggesting selective carbonate formation. Fuel cell experiments were performed with O₂ or O₂/CO₂ on the cathode stream to confirm operation on the carbonate cycle. A considerable increase in performance was observed when CO₂ was added to the cathode stream, specifically up to concentrations of 10%. However, further additions of CO₂ were matched with gradual reduction in fuel cell performance. This was attributed to the high surface basicity of the pyrochlore combined with relatively low electrochemical activity, which causes disproportionate CO₂ adsorption during reaction, hindering the O₂ adsorption required for optimal performance by O₂ site blocking. Thin-film electrodes in O₂-saturated alkaline electrolytes were used to demonstrate its electrochemical stability within the oxygen reduction region. Addition of CO₂ to the electrolyte caused an increase in current, suggesting preferential carbonate formation. Tafel plots showed higher kinetic performance when CO₂ is present on the electrode surface.

The results of these experimentations depict the potential of a Ca₂Ru₂O_{7-y} pyrochlore to electrochemically produce carbonate with high selectivity, instead of hydroxide, therefore enabling RTCFCs. This property can be attributed to the high surface basicity of this catalyst, which led to the preferential adsorption of CO₂ instead of H₂O. Further improvements may be attained by tailoring the catalyst competition to obtain optimal surface basicity and electrochemical activity. Also, optimization of MEA, as well as the use of a carbonate conducting ionomer, would significantly improve device performance.

Although the present disclosure has been described with reference to exemplary embodiments and implementations, it is to be understood that the present disclosure is neither limited by nor restricted to such exemplary embodiments and/or implementations. Rather, the present disclosure is susceptible to various modifications, enhancements and variations without departing from the spirit or scope of the present disclosure. Indeed, the present disclosure expressly encompasses such modifications, enhancements and variations as will be readily apparent to persons skilled in the art from the disclosure herein contained.

1. An electrochemical reactor, comprising:
an anode electrically coupled to a cathode;
an electrolyte in communication with the anode and the cathode;
wherein the anode, cathode and the electrolyte are adapted to operate at a temperature of about 50° C. or less to:
(i) produce carbonate anions at the cathode, and
(ii) transport the carbonate anions from the cathode to the anode via the electrolyte.

2. The electrochemical reactor of claim 1, wherein the anode, cathode and the electrolyte are adapted to operate at about atmospheric pressure to produce and transport the carbonate anions.

3. The electrochemical reactor of claim 1, wherein the carbonate anions are produced via the following equation:
O₂+2CO₂+4e⁻→2CO₃⁻².

4. The electrochemical reactor of claim 1, wherein the electrolyte is a substantially solid, polymer electrolyte.

5. The electrochemical reactor of claim 4, wherein the electrolyte is substantially non-electrically conducting, and includes functional groups that allow for the transport of ions through the functional groups.

6. The electrochemical reactor of claim 1, wherein when a fuel is fed to the anode, the fuel is oxidized by the carbonate anions, thereby yielding CO₂ and water via the following equation:
2H₂+2CO₃⁻²→2CO₂+2H₂O+4e⁻.

7. The electrochemical reactor of claim 6, wherein the yielded CO₂ is emitted from the anode or recycled to the cathode.

8. The electrochemical reactor of claim 6, wherein the yielded CO₂ is separated from the H₂O via a separator.

9. The electrochemical reactor of claim 6, wherein the fuel is hydrogen or alcohol.

10. The electrochemical reactor of claim 1, further comprising a catalyst associated with the anode, the catalyst adapted to absorb the produced carbonate anions and oxidize an incoming anode feed.

11. The electrochemical reactor of claim 10, wherein the anode feed is oxidized to form dimethyl carbonate or formaldehyde.

12. The electrochemical reactor of claim 1, wherein the anode, cathode and the electrolyte are adapted to operate at a temperature of about 15° C. to about 40° C. to produce and transport the carbonate anions.

13. The electrochemical reactor of claim 1, further comprising a catalyst associated with the cathode, the catalyst adapted to selectively form carbonate anions over hydroxide anions under fully humidified conditions.

14. The electrochemical reactor of claim 13, wherein the catalyst preferentially absorbs CO₂ over H₂O, catalytically activates the 0=0 bond, and has high electronic conductivity.

15. The electrochemical reactor of claim 13, wherein the catalyst is tri-functional and is a single compound.

16. The electrochemical reactor of claim 13, wherein the catalyst is an alkaline earth pyrochlore.

17. The electrochemical reactor of claim 13, wherein the catalyst has a molecular structure of A₂B₂O_{7-y}, and wherein the A and B sites may be individually controlled to tailor the catalytic properties of the catalyst and the oxygen vacancy (y) gives the catalyst conductivity.

18. The electrochemical reactor of claim 17, wherein an alkaline earth metal is selected from the group consisting of Ca, Mg, Ba and Sr is at the A site.

19. The electrochemical reactor of claim 17, wherein a high activity oxygen reduction reaction catalyst in alkaline media is at the B site.

20. The electrochemical reactor of claim 17, wherein the A and B sites take the form of single components.

21. The electrochemical reactor of claim 17, wherein the A and B sites take the form of combined components.

22. The electrochemical reactor of claim 17, wherein the A site takes the form of a combination of Ca_{0.5} and Ba_{1.5.}

23. The electrochemical reactor of claim 17, wherein the B site takes the form of RuPt.

24. An electrocatalyst, comprising:
a pyrochlore having a molecular structure of A₂B₂O_{7-y},
wherein the A and B sites may be individually controlled to tailor the catalytic properties of a disclosed catalyst, and the oxygen vacancy gives the catalyst conductivity.

25. The electrocatalyst of claim 24, wherein the pyrochlore is an alkaline earth pyrochlore.

26. The electrocatalyst of claim 24, wherein an alkaline earth metal is selected from the group consisting of Ca, Mg, Ba and Sr is at the A site.

27. The electrocatalyst of claim 24, wherein a high activity oxygen reduction reaction catalyst in alkaline media is at the B site.

28. The electrocatalyst of claim 24, wherein the A and B sites take the form of single components.

29. The electrocatalyst of claim 24, wherein the A and B sites take the form of combined components.

30. The electrocatalyst of claim 24, wherein the A site takes the form of a combination of Ca_{0.5} and Ba_{1.5.}

31. The electrocatalyst of claim 24, wherein the B site takes the form of RuPt.

32. The electrochemical reactor of claim 13, wherein the catalyst is Ca₂Ru₂O_{7-y}.

33. The electrocatalyst of claim 24, wherein the pyrochlore is Ca₂Ru₂O_{7-y}.

34. The electrochemical reactor of claim 13, wherein the catalyst is Ca_{1.5}Ba_{0.5}PtRu_{O7-y}.

35. The electrocatalyst of claim 24, wherein the pyrochlore is Ca_{1.5}Ba_{0.5}PtRu_{O7-y}.

36. A method of fabricating an electrochemical reactor, the method comprising:
a. providing an anode electrically coupled to a cathode; and
b. providing an electrolyte in communication with the anode and the cathode,
wherein the anode, cathode and the electrolyte are adapted to operate at a temperature of about 50° C. or less to:
(i) produce carbonate anions at the cathode, and
(ii) transport the carbonate anions from the cathode to the anode via the electrolyte.

37. The method of claim 36, wherein the anode, cathode and the electrolyte are adapted to operate at about atmospheric pressure to produce and transport the carbonate anions.

38. The method of claim 36, further comprising providing a catalyst associated with the anode, the catalyst adapted to absorb the produced carbonate anions and oxidize an incoming anode feed.

39. The method of claim 36, further comprising providing a catalyst associated with the cathode, the catalyst adapted to selectively form carbonate anions over hydroxide anions under fully humidified conditions.

40. The electrochemical reactor of claim 10, wherein the anode feed is oxidized to form syngas.

41. The electrochemical reactor of claim 40, wherein the anode feed includes methane or a mixture of methane and carbon dioxide.

42. The electrochemical reactor of claim 10, wherein the catalyst is a co-precipitated transition metal oxide:ZrO₂ electrocatalyst.

43. The electrochemical reactor of claim 42, wherein the catalyst is selected from the group consisting of a co-precipitated NiO/ZrO₂ composite catalyst, a co-precipitated CoO/ZrO₂ composite catalyst and a co-precipitated MnO/ZrO₂ composite catalyst.
